(19) United States
(12) Patent Application Publication
(10) Pub. No.: US 2016/0195691 A1
(43) Pub. Date: Jul. 7, 2016

(54) IMAGING OPTICAL SYSTEM

(71) Applicant: Panasonic Intellectual Property Management Co., Ltd., Osaka (JP)

(72) Inventors: Takakazu BITO, Osaka (JP); Shunichiro YOSHINAGA, Osaka (JP); Hideki KAI, Osaka (JP); Tsutomu IWASHITA, Osaka (JP); Yoshiaki KURIOKA, Osaka (JP); Aya TOMITA, Osaka (JP); Hisayuki II, Osaka (JP)

(21) Appl. No.: 15/070,507

(22) Filed: Mar. 15, 2016

Related U.S. Application Data
(63) Continuation of application No. PCT/JP2014/004828, filed on Sep. 19, 2014.

(30) Foreign Application Priority Data
Sep. 20, 2013 (JP) 2013-195260
Oct. 4, 2013 (JP) 2013-208794
Nov. 12, 2013 (JP) 2013-233734
Nov. 14, 2013 (JP) 2013-235672
Mar. 7, 2014 (JP) 2014-044594

(51) Int. Cl. G02B 9/34; G02B 13/24; G02B 27/00

(52) U.S. Cl. CPC G02B 9/34; G02B 27/0025; G02B 13/24

(57) ABSTRACT

An imaging optical system, in order from an object side to an image side, includes: a first lens unit having positive optical power; and a second lens unit. In focusing from an infinity in-focus condition to a close-object in-focus condition, the first lens unit moves along an optical axis, and the second lens unit is fixed with respect to an image surface. The imaging optical system is compact, sufficiently suppresses occurrence of various aberrations, has high resolution from the infinity in-focus condition to the close-object in-focus condition, is bright and highly efficient, and is suitable for wide-angle photographing.

### CROSS REFERENCE OF RELATED APPLICATIONS

This application is a Continuation of International Application No. PCT/JP2014/004828, filed on Sep. 19, 2014, which in turn claims the benefit of Japanese Applications No. 2013-195260 filed on Sep. 20, 2013, No. 2013-208794 filed on Oct. 4, 2013, No. 2013-233734 filed on Nov. 12, 2013, No. 2013-235672 filed on Nov. 14, 2013, and No. 2014-044594 filed on Mar. 7, 2014, the disclosures of which Applications are incorporated by reference herein.

### BACKGROUND

1. Field

The present disclosure relates to imaging optical systems.

2. Description of the Related Art

International Publication No. 2010/143459 discloses an imaging lens system in which a lens disposed on an imaging element side is fixed, and a lens unit having a plurality of lenses including a lens closest to a subject is moved in an optical axis direction to perform focusing.

Japanese Laid-Open Patent Publication No. 2013-195688 discloses an imaging optical system which is composed of four or five lenses, and the entire system is moved on an optical axis to perform focusing.

### SUMMARY

The present disclosure provides an imaging optical system which is compact, sufficiently suppresses occurrence of various aberrations, has high resolution from an infinity in-focus condition to a close-object in-focus condition, is bright and highly efficient, and is suitable for wide-angle photographing.

An imaging optical system according to the present disclosure, in order from an object side to an image side, includes: a first lens unit having positive optical power; and a second lens unit. In focusing from an infinity in-focus condition to a close-object in-focus condition, the first lens unit moves along an optical axis, and the second lens unit is fixed with respect to an image surface. The first lens unit, in order from an object side to an image side, is composed of a first lens element having negative optical power, and at least one subsequent lens element. An aperture diaphragm is disposed between the first lens element and the subsequent lens element.

The imaging optical system according to the present disclosure is compact, sufficiently suppresses occurrence of various aberrations, has high resolution from an infinity in-focus condition to a close-object in-focus condition, is bright and highly efficient, and is suitable for wide-angle photographing.

### BRIEF DESCRIPTION OF THE DRAWINGS

FIG. 1 is a lens arrangement diagram of an imaging optical system according to Embodiment I-1 (Numerical Example I-1);

FIG. 2 is a longitudinal aberration diagram of the imaging optical system according to Numerical Example I-1;

FIG. 3 is a schematic structural diagram of a mobile terminal to which the imaging optical system according to Embodiment I-1 is applied;

FIG. 4 is a lens arrangement diagram of an imaging optical system according to Embodiment II-1 (Numerical Example II-1);

FIG. 5 is a longitudinal aberration diagram of the imaging optical system according to Numerical Example II-1;

FIG. 6 is a lens arrangement diagram of an imaging optical system according to Embodiment II-2 (Numerical Example II-2);

FIG. 7 is a longitudinal aberration diagram of the imaging optical system according to Numerical Example II-2;

FIG. 8 is a lens arrangement diagram of an imaging optical system according to Embodiment II-3 (Numerical Example II-3);

FIG. 9 is a longitudinal aberration diagram of the imaging optical system according to Numerical Example II-3;

FIG. 10 is a lens arrangement diagram of an imaging optical system according to Embodiment II-4 (Numerical Example II-4);

FIG. 11 is a longitudinal aberration diagram of the imaging optical system according to Numerical Example II-4;

FIG. 12 is a lens arrangement diagram of an imaging optical system according to Embodiment II-2 (Numerical Example II-5);

FIG. 13 is a longitudinal aberration diagram of the imaging optical system according to Numerical Example II-5;

FIG. 14 is a schematic structural diagram of a mobile terminal to which the imaging optical system according to Embodiment II-1 is applied;

FIG. 15 is a lens arrangement diagram of an imaging optical system according to Embodiment III-1 (Numerical Example III-1);

FIG. 16 is a longitudinal aberration diagram of the imaging optical system according to Numerical Example III-1;

FIG. 17 is a lens arrangement diagram of an imaging optical system according to Embodiment III-2 (Numerical Example III-2);

FIG. 18 is a longitudinal aberration diagram of the imaging optical system according to Numerical Example III-2;

FIG. 19 is a lens arrangement diagram of an imaging optical system according to Embodiment III-3 (Numerical Example III-3);

FIG. 20 is a longitudinal aberration diagram of the imaging optical system according to Numerical Example III-3;

FIG. 21 is a schematic structural diagram of a mobile terminal to which the imaging optical system according to Embodiment III-1 is applied;

FIG. 22 is a lens arrangement diagram of an imaging optical system according to Embodiment IV-1 (Numerical Example IV-1);

FIG. 23 is a longitudinal aberration diagram of the imaging optical system according to Numerical Example IV-1;

FIG. 24 is a lens arrangement diagram of an imaging optical system according to Embodiment IV-2 (Numerical Example IV-2);

FIG. 25 is a longitudinal aberration diagram of the imaging optical system according to Numerical Example Iv-2;

FIG. 26 is a lens arrangement diagram of an imaging optical system according to Embodiment IV-3 (Numerical Example IV-3);

FIG. 27 is a longitudinal aberration diagram of the imaging optical system according to Numerical Example IV-3;

FIG. 28 is a schematic structural diagram of a mobile terminal to which the imaging optical system according to Embodiment IV-1 is applied;

FIG. 29 is a lens arrangement diagram of an imaging optical system according to Embodiment V-1 (Numerical Example V-1);

FIG. 30 is a longitudinal aberration diagram of the imaging optical system according to Numerical Example V-1;

FIG. 31 is a lateral aberration diagram in a basic state where image blur compensation is not performed, of the imaging optical system according to Numerical Example V-1;

FIG. 32 is a lens arrangement diagram of an imaging optical system according to Embodiment V-2 (Numerical Example V-2);

FIG. 33 is a longitudinal aberration diagram of the imaging optical system according to Numerical Example V-2;

FIG. 34 is a lateral aberration diagram in a basic state where image blur compensation is not performed, of the imaging optical system according to Numerical Example V-2; and

FIG. 35 is a schematic structural diagram of a mobile terminal to which the imaging optical system according to Embodiment V-1 is applied.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the inventors provide the attached drawings and the following description so that those skilled in the art can fully understand this disclosure. Therefore, the drawings and description are not intended to limit the subject defined by the claims.

In the present disclosure, a lens unit is a unit composed of at least one lens element, and the optical power, composite focal length, and the like of each lens unit are determined on the basis of the types, number, arrangement, and the like of the lens elements constituting the lens unit.

(Embodiments of Imaging Optical System)

A single-focus imaging optical system according to the present disclosure, in order from the object side to the image side, comprises a first lens unit having positive optical power and a second lens unit having optical power. In focusing from an infinity in-focus condition to a close-object in-focus condition, the first lens unit moves along the optical axis, and the second lens unit is fixed with respect to an image surface. Accordingly, the imaging optical system according to the present disclosure can maintain high optical performance even in the close-object in-focus condition.

### (I) Embodiment I

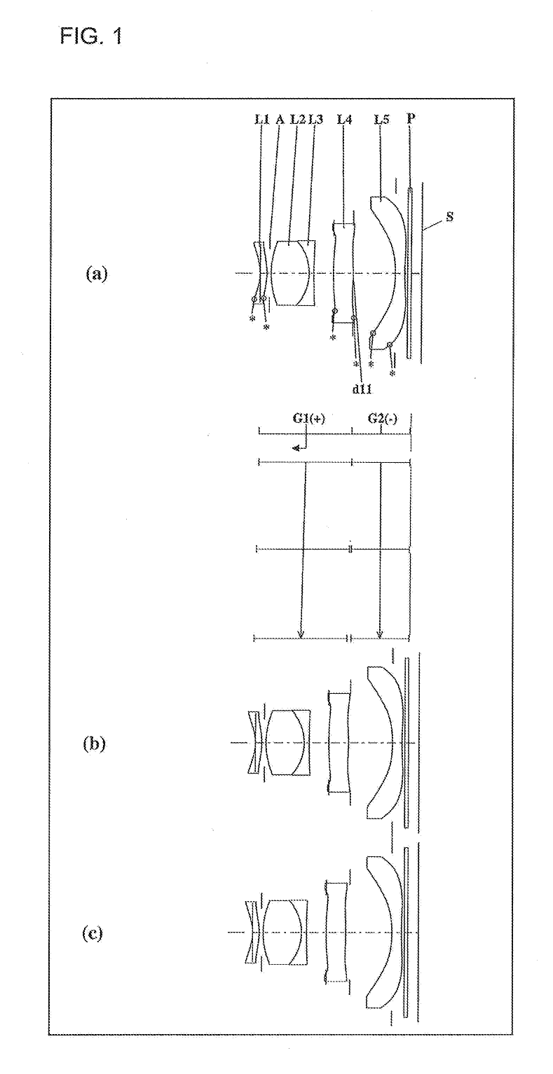

FIG. 1 is a lens arrangement diagram of an imaging optical system according to Embodiment I-1. In FIG. 1, part (a) shows an infinity in-focus condition, part (b) shows a close-object in-focus condition (object point distance: 30 cm), and part (c) shows a close-object in-focus condition (object point distance: 15 cm). In FIG. 1, an arrow parallel to the optical axis, which is imparted to a lens unit, indicates a moving direction of the lens unit in focusing from the infinity in-focus condition to the close-object in-focus condition. In FIG. 1, asterisk “*” imparted to a particular surface indicates that the surface is aspheric. In FIG. 1, symbol (+) or (−) imparted to the symbol of each lens unit corresponds to the sign of the optical power of the lens unit. In FIG. 1, a straight line located on the most right-hand side indicates the position of the image surface S.

### Embodiment I-1

As shown in FIG. 1, a first lens unit G1 has positive optical power, and, in order from the object side to the image side, comprises: a negative meniscus first lens element L1 with the concave surface facing the object side; a bi-convex second lens element L2; a bi-concave third lens element L3; and a bi-convex fourth lens element L4. Among these lenses, the second lens element L2 and the third lens element L3 are cemented with each other. In the surface data of the corresponding Numerical Example described later, a surface number 6 is imparted to an adhesive layer between the second lens element L2 and the third lens element L3.

A second lens unit G2 has negative optical power, and comprises solely a bi-concave fifth lens element L5.

An aperture diaphragm A is disposed on the image side relative to the first lens element L1, and a parallel plate P is disposed on the object side relative to the image surface S (between the image surface S and the fifth lens element L5).

The first lens element L1, the fourth lens element L4, and the fifth lens element L5 are made of a resin material. The first lens element L1, the fourth lens element L4, and the fifth lens element L5 each have two aspheric surfaces.

In the imaging optical system according to Embodiment I-1, in focusing from the infinity in-focus condition to the close-object in-focus condition, the first lens unit G1 moves to the object side along the optical axis, and the second lens unit G2 is fixed with respect to the image surface S. Thus, high optical performance can be maintained even in the close-object in-focus condition.

The first lens unit G1 moves in a direction perpendicular to the optical axis to optically compensate for image blur. By the first lens unit G1, image point movement caused by vibration of the entire system is compensated for, that is, image blur caused by hand blurring, vibration and the like is optically compensated for.

### (II) Embodiment II

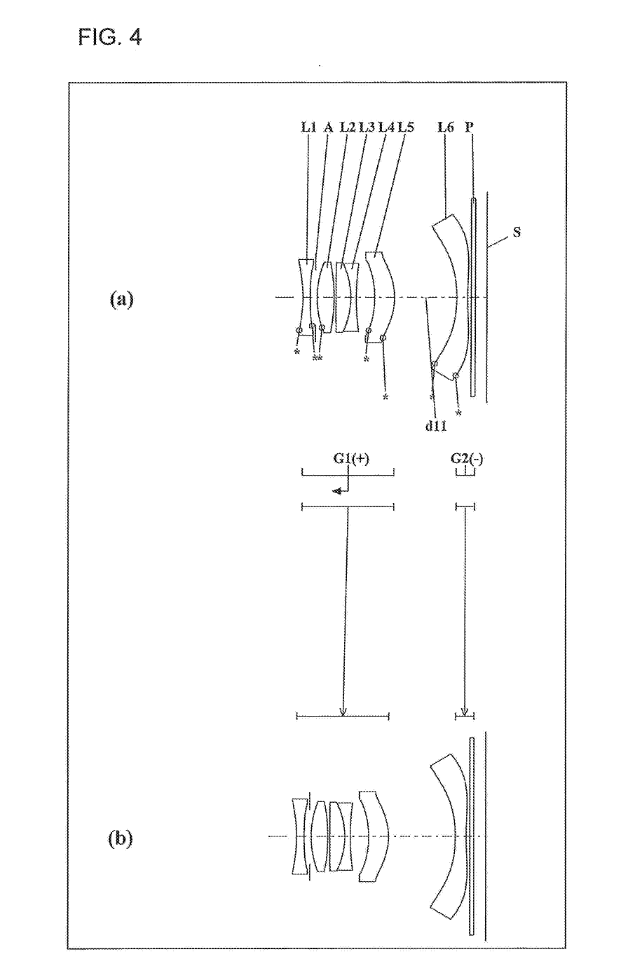

FIGS. 4, 6, 8, 10 and 12 are lens arrangement diagrams of imaging optical systems according to Embodiments II-1 to II-5, in which part (a) shows an infinity in-focus condition, and part (b) shows a close-object in-focus condition. In each FIG., an arrow parallel to the optical axis, which is imparted to a lens unit, indicates a moving direction of the lens unit in focusing from the infinity in-focus condition to the close-object in-focus condition. In each FIG., asterisk “*” imparted to a particular surface indicates that the surface is aspheric. In each FIG., symbol (+) or (−) imparted to the symbol of each lens unit corresponds to the sign of the optical power of the lens unit. In each FIG., a straight line located on the most right-hand side indicates the position of the image surface S.

### Embodiment II-1

As shown in FIG. 4, a first lens unit G1 has positive optical power, and, in order from the object side to the image side, comprises: a bi-concave first lens element L1; a bi-convex second lens element L2; a bi-convex third lens element L3; a bi-concave fourth lens element L4; and a positive meniscus fifth lens element L5 with the concave surface facing the object side. Among these lenses, the third lens element L3 and the fourth lens element L4 are cemented with each other. In the surface data of the corresponding Numerical Example described later, a surface number 7 is imparted to an adhesive layer between the third lens element L3 and the fourth lens element L4.

A second lens unit G2 has negative optical power, and comprises solely a bi-concave sixth lens element L6.

An aperture diaphragm A is disposed on the image side relative to the first lens element L1, and a parallel plate P is disposed on the object side relative to the image surface S (between the image surface S and the sixth lens element L6).

The first lens element L1, the fifth lens element L5, and the sixth lens element L6 are made of a resin material. The both surfaces of the first lens element L1, the object-side surface of the second lens element L2, the both surfaces of the fifth lens element L5, and the both surfaces of the sixth lens element L6 are aspheric surfaces.

In the imaging optical system according to Embodiment II-1, in focusing from the infinity in-focus condition to the close-object in-focus condition, the first lens unit G1 moves to the object side along the optical axis, and the second lens unit G2 is fixed with respect to the image surface S. Thus, high optical performance can be maintained even in the close-object in-focus condition.

The first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

### Embodiment II-2

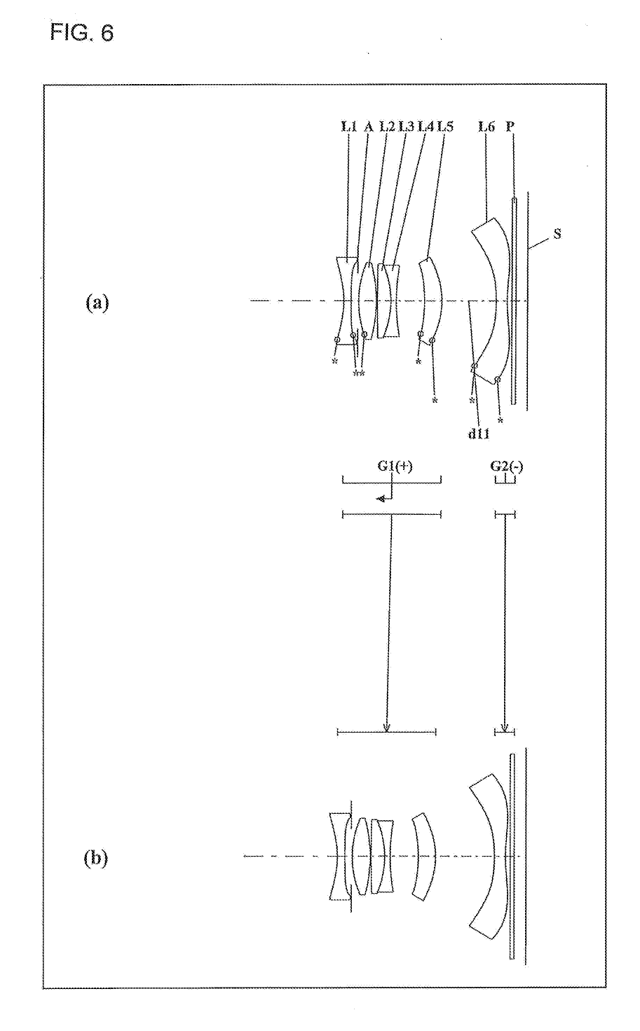

As shown in FIG. 6, a first lens unit G1 has positive optical power, and, in order from the object side to the image side, comprises: a bi-concave first lens element L1; a bi-convex second lens element L2; a bi-convex third lens element L3; a bi-concave fourth lens element L4; and a positive meniscus fifth lens element L5 with the concave surface facing the object side. Among these lenses, the third lens element L3 and the fourth lens element L4 are cemented with each other. In the surface data of the corresponding Numerical Example described later, a surface number 7 is imparted to an adhesive layer between the third lens element L3 and the fourth lens element L4.

A second lens unit G2 has negative optical power, and comprises solely a bi-concave sixth lens element L6.

An aperture diaphragm A is disposed on the image side relative to the first lens element L1, and a parallel plate P is disposed on the object side relative to the image surface S (between the image surface S and the sixth lens element L6).

The first lens element L1, the fifth lens element L5, and the sixth lens element L6 are made of a resin material. The both surfaces of the first lens element L1, the object-side surface of the second lens element L2, the both surfaces of the fifth lens element L5, and the both surfaces of the sixth lens element L6 are aspheric surfaces.

In the imaging optical system according to Embodiment II-2, in focusing from the infinity in-focus condition to the close-object in-focus condition, the first lens unit G1 moves to the object side along the optical axis, and the second lens unit G2 is fixed with respect to the image surface S. Thus, high optical performance can be maintained even in the close-object in-focus condition.

The first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

### Embodiment II-3

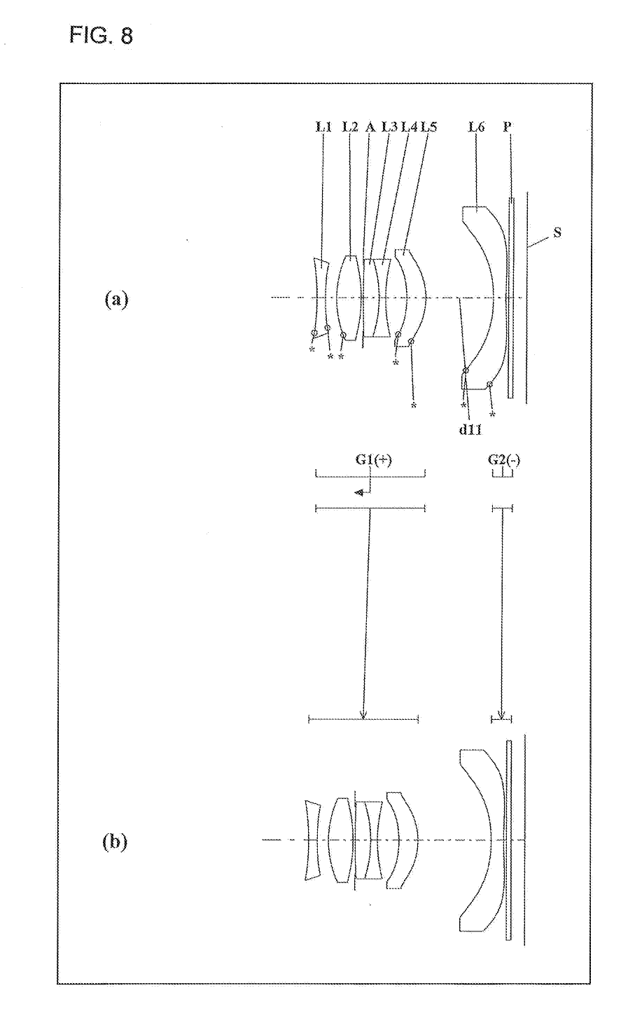

As shown in FIG. 8, a first lens unit G1 has positive optical power, and, in order from the object side to the image side, comprises: a bi-concave first lens element L1; a bi-convex second lens element L2; a bi-convex third lens element L3; a bi-concave fourth lens element L4; and a positive meniscus fifth lens element L5 with the concave surface facing the object side. Among these lenses, the third lens element L3 and the fourth lens element L4 are cemented with each other. In the surface data of the corresponding Numerical Example described later, a surface number 7 is imparted to an adhesive layer between the third lens element L3 and the fourth lens element L4.

A second lens unit G2 has negative optical power, and comprises solely a bi-concave sixth lens element L6.

An aperture diaphragm A is disposed on the image side relative to the second lens element L2, and a parallel plate P is disposed on the object side relative to the image surface S (between the image surface S and the sixth lens element L6).

The first lens element L1, the fifth lens element L5, and the sixth lens element L6 are made of a resin material. The both surfaces of the first lens element L1, the object-side surface of the second lens element L2, the both surfaces of the fifth lens element L5, and the both surfaces of the sixth lens element L6 are aspheric surfaces.

In the imaging optical system according to Embodiment II-3, in focusing from the infinity in-focus condition to the close-object in-focus condition, the first lens unit G1 moves to the object side along the optical axis, and the second lens unit G2 is fixed with respect to the image surface S. Thus, high optical performance can be maintained even in the close-object in-focus condition.

The first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

### Embodiment II-4

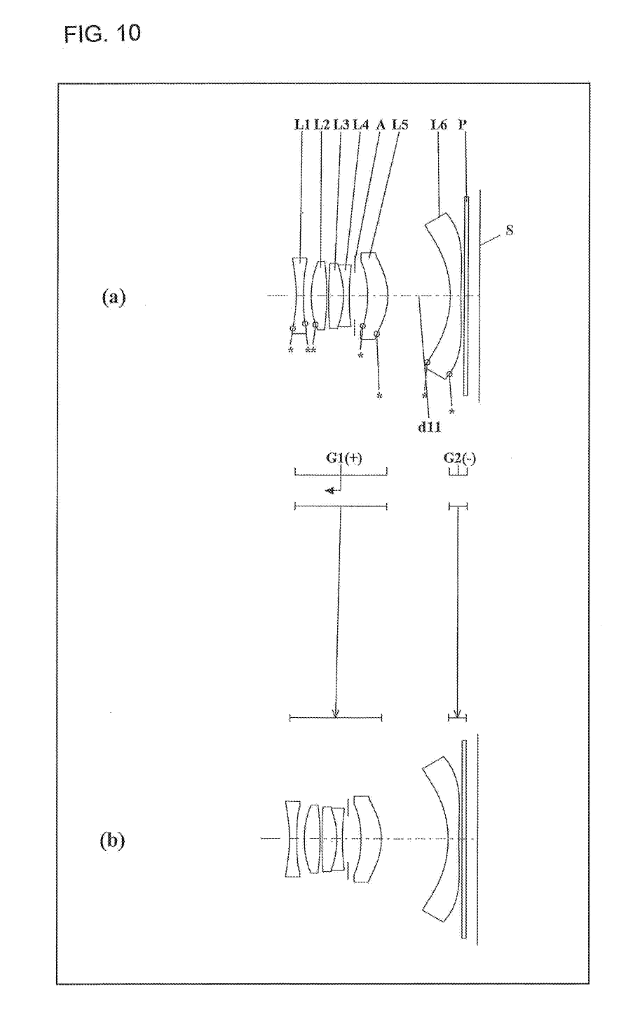

As shown in FIG. 10, a first lens unit G1 has positive optical power, and, in order from the object side to the image side, comprises: a bi-concave first lens element L1; a bi-convex second lens element L2; a bi-convex third lens element L3; a bi-concave fourth lens element L4; and a positive meniscus fifth lens element L5 with the concave surface facing the object side. Among these lenses, the third lens element L3 and the fourth lens element L4 are cemented with each other. In the surface data of the corresponding Numerical Example described later, a surface number 6 is imparted to an adhesive layer between the third lens element L3 and the fourth lens element L4.

A second lens unit G2 has negative optical power, and comprises solely a bi-concave sixth lens element L6.

An aperture diaphragm A is disposed on the image side relative to the fourth lens element L4, and a parallel plate P is disposed on the object side relative to the image surface S (between the image surface S and the sixth lens element L6).

The first lens element L1, the fifth lens element L5, and the sixth lens element L6 are made of a resin material. The both surfaces of the first lens element L1, the object-side surface of the second lens element L2, the both surfaces of the fifth lens element L5, and the both surfaces of the sixth lens element L6 are aspheric surfaces.

In the imaging optical system according to Embodiment II-4, in focusing from the infinity in-focus condition to the close-object in-focus condition, the first lens unit G1 moves to the object side along the optical axis, and the second lens unit G2 is fixed with respect to the image surface S. Thus, high optical performance can be maintained even in the close-object in-focus condition.

The first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

### Embodiment II-5

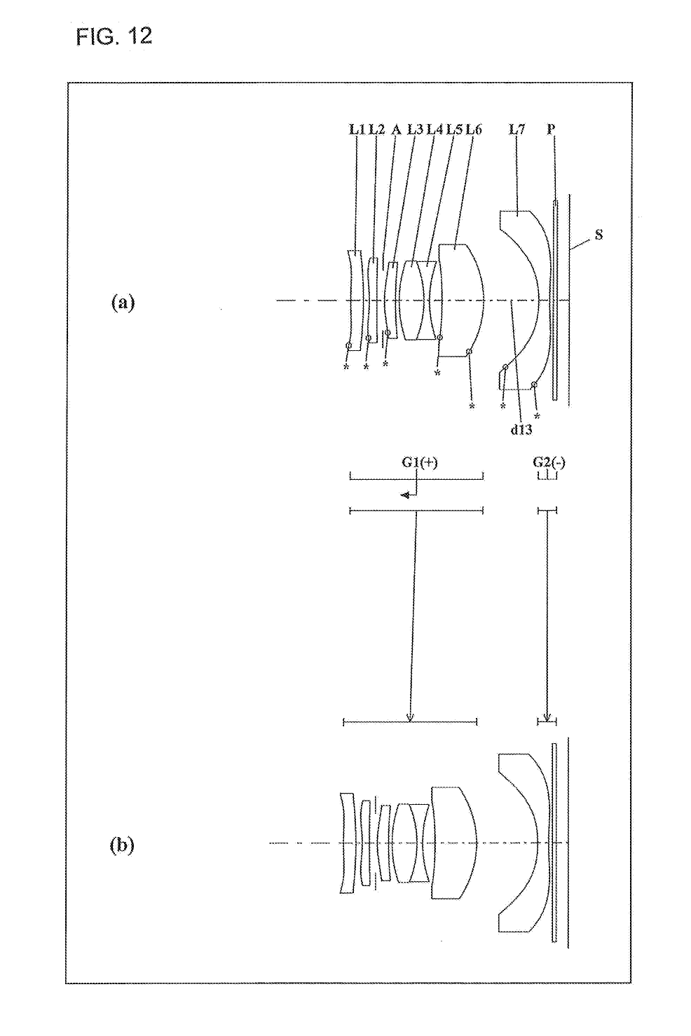

As shown in FIG. 12, a first lens unit G1 has positive optical power, and, in order from the object side to the image side, comprises: a bi-convex first lens element L1; a bi-concave second lens element L2; a positive meniscus third lens element L3 with the convex surface facing the object side; a bi-convex fourth lens element L4; a bi-concave fifth lens element L5; and a positive meniscus sixth lens element L6 with the concave surface facing the object side. Among these lenses, the fourth lens element L4 and the fifth lens element L5 are cemented with each other. In the surface data of the corresponding Numerical Example described later, a surface number 9 is imparted to an adhesive layer between the fourth lens element L4 and the fifth lens element L5.

A second lens unit G2 has negative optical power, and comprises solely a bi-concave seventh lens element L7.

An aperture diaphragm A is disposed on the image side relative to the second lens element L2, and a parallel plate P is disposed on the object side relative to the image surface S (between the image surface S and the seventh lens element L7).

The first lens element L1, the second lens element L2, the third lens element L3, the sixth lens element L6, and the seventh lens element L7 are made of a resin material. The object-side surface of the first lens element L1, the object-side surface of the second lens element L2, the object-side surface of the third lens element L3, the both surfaces of the sixth lens element L6, and the both surfaces of the seventh lens element L7 are aspheric surfaces.

In the imaging optical system according to Embodiment II-5, in focusing from the infinity in-focus condition to the close-object in-focus condition, the first lens unit G1 moves to the object side along the optical axis, and the second lens unit G2 is fixed with respect to the image surface S. Thus, high optical performance can be maintained even in the close-object in-focus condition.

The first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

### (III) Embodiment III

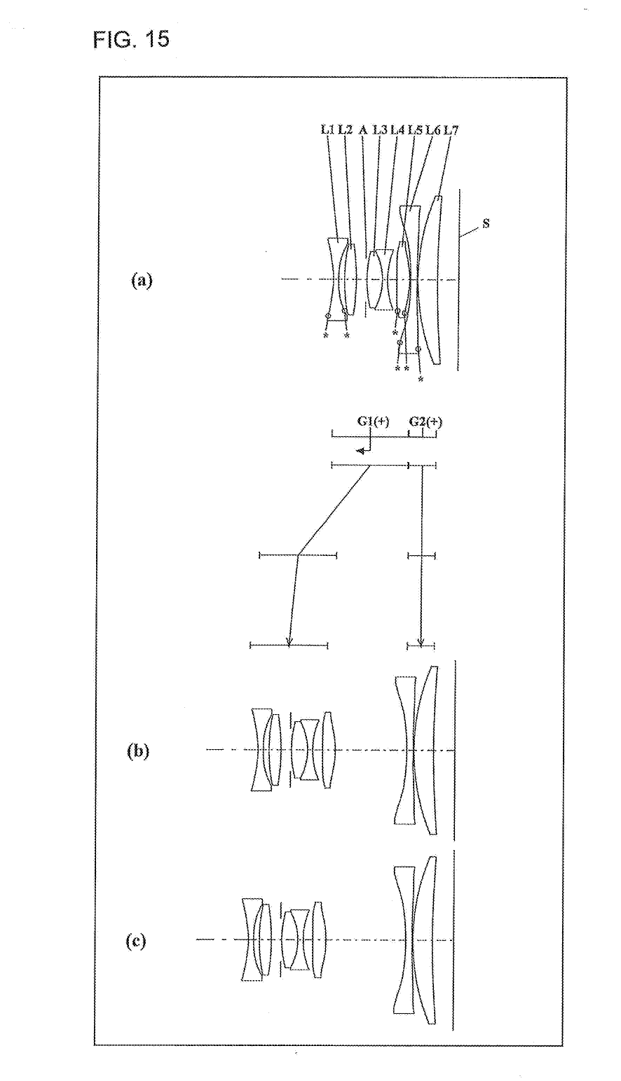

FIGS. 15, 17, and 19 are lens arrangement diagrams of imaging optical systems according to Embodiments III-1 to III-3, in which part (a) shows a non-used state (retracted state), part (b) shows an infinity in-focus condition, and part (c) shows a close-object in-focus condition. In each FIG., an arrow parallel to the optical axis, which is imparted to a lens unit, indicates a moving direction of the lens unit in focusing from the infinity in-focus condition to the close-object in-focus condition. In each FIG., asterisk “*” imparted to a particular surface indicates that the surface is aspheric. In each FIG., symbol (+) or (−) imparted to the symbol of each lens unit corresponds to the sign of the optical power of the lens unit. In each FIG., a straight line located on the most right-hand side indicates the position of the image surface S.

### Embodiment III-1

As shown in FIG. 15, a first lens unit G1 has positive optical power, and, in order from the object side to the image side, comprises: a bi-concave first lens element L1; a bi-convex second lens element L2; a bi-convex third lens element L3; a bi-concave fourth lens element L4; and a positive meniscus fifth lens element L5 with the concave surface facing the object side. Among these lenses, the third lens element L3 and the fourth lens element L4 are cemented with each other. In the surface data of the corresponding Numerical Example described later, a surface number 7 is imparted to an adhesive layer between the third lens element L3 and the fourth lens element L4.

A second lens unit G2 has positive optical power, and, in order from the object side to the image side, comprises: a bi-concave sixth lens element L6; and a positive meniscus seventh lens element L7 with the convex surface facing the object side.

An aperture diaphragm A is disposed on the image side relative to the second lens element L2.

The both surfaces of the first lens element L1, the both surfaces of the fifth lens element L5, and the both surfaces of the sixth lens element L6 are aspheric surfaces.

In the imaging optical system according to Embodiment III-1, the first lens unit G1 moves to the object side along the optical axis in focusing from the infinity in-focus condition to the close-object in-focus condition, and the first lens unit G1 moves to the image side along the optical axis when it is retracted from the infinity in-focus condition to the non-used state. In focusing and in retraction, the second lens unit G2 is fixed with respect to the image surface S.

### Embodiment III-2

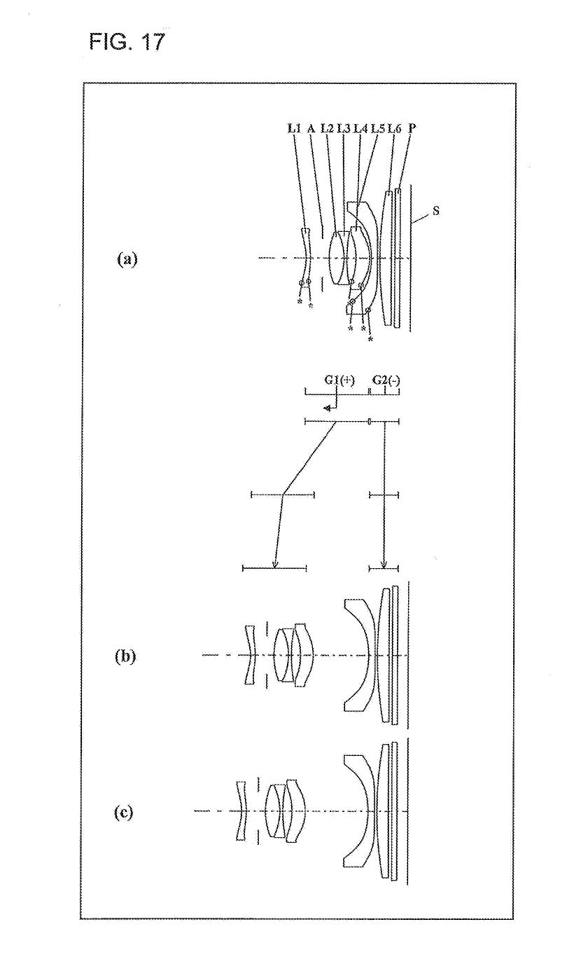

As shown in FIG. 17, a first lens unit G1 has positive optical power, and, in order from the object side to the image side, comprises: a negative meniscus first lens element L1 with the concave surface facing the object side; a bi-convex second lens element L2; a bi-concave third lens element L3; and a positive meniscus fourth lens element L4 with the concave surface facing the object side. Among these lenses, the second lens element L2 and the third lens element L3 are cemented with each other. In the surface data of the corresponding Numerical Example described later, a surface number 5 is imparted to an adhesive layer between the second lens element L2 and the third lens element L3.

A second lens unit G2 has negative optical power, and, in order from the object side to the image side, comprises: a bi-concave fifth lens element L5; and a positive meniscus sixth lens element L6 with the convex surface facing the object side.

An aperture diaphragm A is disposed on the image side relative to the first lens element L1, and a parallel plate P is disposed on the object side relative to the image surface S (between the image surface S and the sixth lens element L6).

The both surfaces of the first lens element L1, the both surfaces of the fourth lens element L4, and the both surfaces of the fifth lens element L5 are aspheric surfaces.

In the imaging optical system according to Embodiment III-2, the first lens unit G1 moves to the object side along the optical axis in focusing from the infinity in-focus condition to the close-object in-focus condition, and the first lens unit G1 moves to the image side along the optical axis when it is retracted from the infinity in-focus condition to the non-used state. In focusing and in retraction, the second lens unit G2 is fixed with respect to the image surface S.

### Embodiment III-3

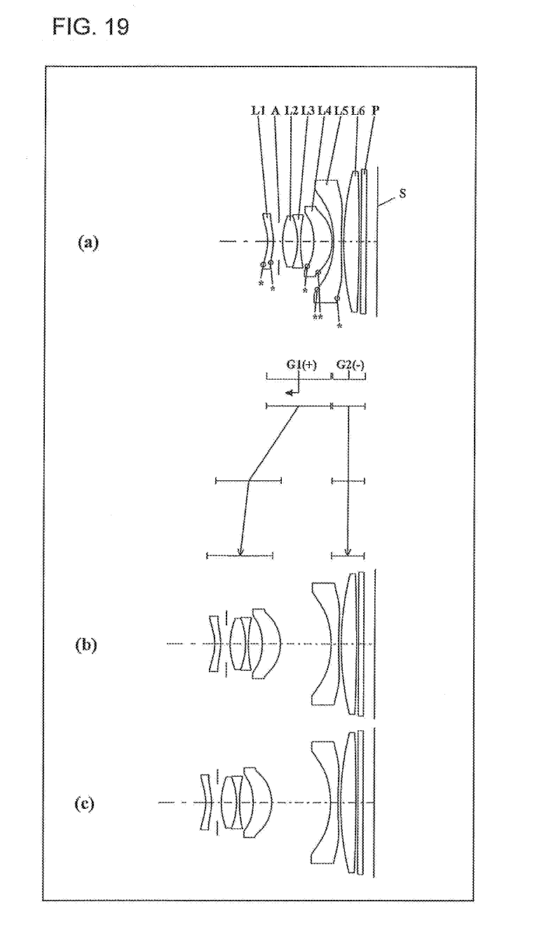

As shown in FIG. 19, a first lens unit G1 has positive optical power, and, in order from the object side to the image side, comprises: a negative meniscus first lens element L1 with the concave surface facing the object side; a bi-convex second lens element L2; a bi-concave third lens element L3; and a positive meniscus fourth lens element L4 with the concave surface facing the object side. Among these lenses, the second lens element L2 and the third lens element L3 are cemented with each other. In the surface data of the corresponding Numerical Example described later, a surface number 5 is imparted to an adhesive layer between the second lens element L2 and the third lens element L3.

A second lens unit G2 has negative optical power, and, in order from the object side to the image side, comprises: a bi-concave fifth lens element L5; and a bi-convex sixth lens element L6.

An aperture diaphragm A is disposed on the image side relative to the first lens element L1, and a parallel plate P is disposed on the object side relative to the image surface S (between the image surface S and the sixth lens element L6).

The both surfaces of the first lens element L1, the both surfaces of the fourth lens element L4, and the both surfaces of the fifth lens element L5 are aspheric surfaces.

In the imaging optical system according to Embodiment III-3, the first lens unit G1 moves to the object side along the optical axis in focusing from the infinity in-focus condition to the close-object in-focus condition, and the first lens unit G1 moves to the image side along the optical axis when it is retracted from the infinity in-focus condition to the non-used state. In focusing and in retraction, the second lens unit G2 is fixed with respect to the image surface S.

### (IV) Embodiment IV

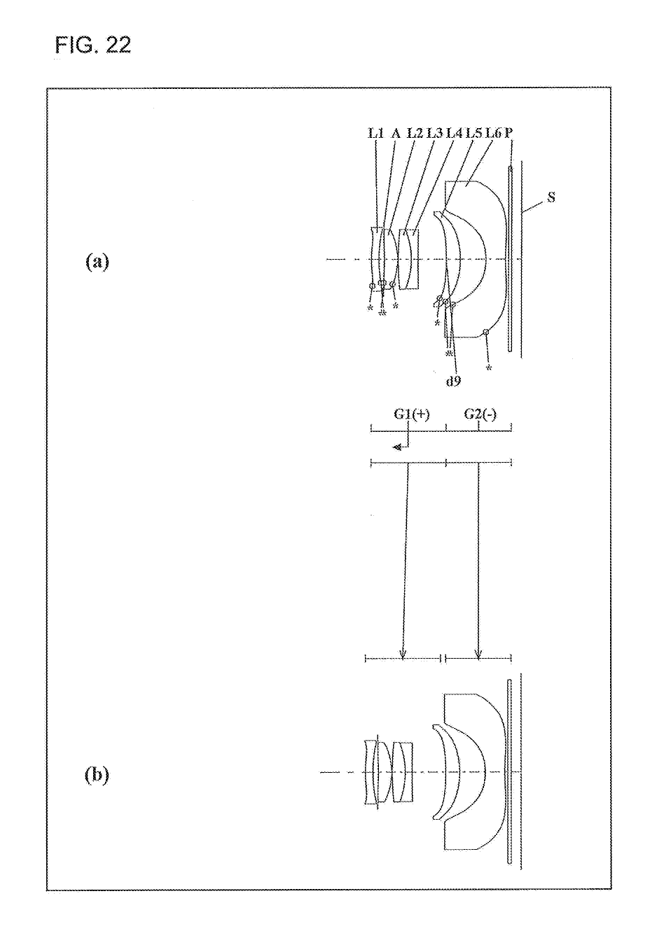

FIGS. 22, 24, and 26 are lens arrangement diagrams of imaging optical systems according to Embodiments IV-1 to IV-3, in which part (a) shows an infinity in-focus condition and part (b) shows a close-object in-focus condition. In each FIG., an arrow parallel to the optical axis, which is imparted to a lens unit, indicates a moving direction of the lens unit in focusing from the infinity in-focus condition to the close-object in-focus condition. In each FIG., asterisk “*” imparted to a particular surface indicates that the surface is aspheric. In each FIG., symbol (+) or (−) imparted to the symbol of each lens unit corresponds to the sign of the optical power of the lens unit. In each FIG., a straight line located on the most right-hand side indicates the position of the image surface S.

### Embodiment IV-1

As shown in FIG. 22, a first lens unit G1 has positive optical power, and, in order from the object side to the image side, comprises: a positive meniscus first lens element L1 with the convex surface facing the object side; a positive meniscus second lens element L2 with the concave surface facing the object side; a bi-convex third lens element L3; and a bi-concave fourth lens element L4. Among these lenses, the third lens element L3 and the fourth lens element L4 are cemented with each other. In the surface data of the corresponding Numerical Example described later, a surface number 7 is imparted to an adhesive layer between the third lens element L3 and the fourth lens element L4.

A second lens unit G2 has negative optical power, and, in order from the object side to the image side, comprises: a positive meniscus fifth lens element L5 with the concave surface facing the object side; and a bi-concave sixth lens element L6.

An aperture diaphragm A is disposed on the image side relative to the first lens element L1, and a parallel plate P is disposed on the object side relative to the image surface S (between the image surface S and the sixth lens element L6).

The both surfaces of the first lens element L1, the both surfaces of the second lens element L2, the both surfaces of the fifth lens element L5; and the both surfaces of the sixth lens element L6 are aspheric surfaces.

In the imaging optical system according to Embodiment IV-1, in focusing from the infinity in-focus condition to the close-object in-focus condition, the first lens unit G1 moves to the object side along the optical axis, and the second lens unit G2 is fixed with respect to the image surface S.

### Embodiment IV-2

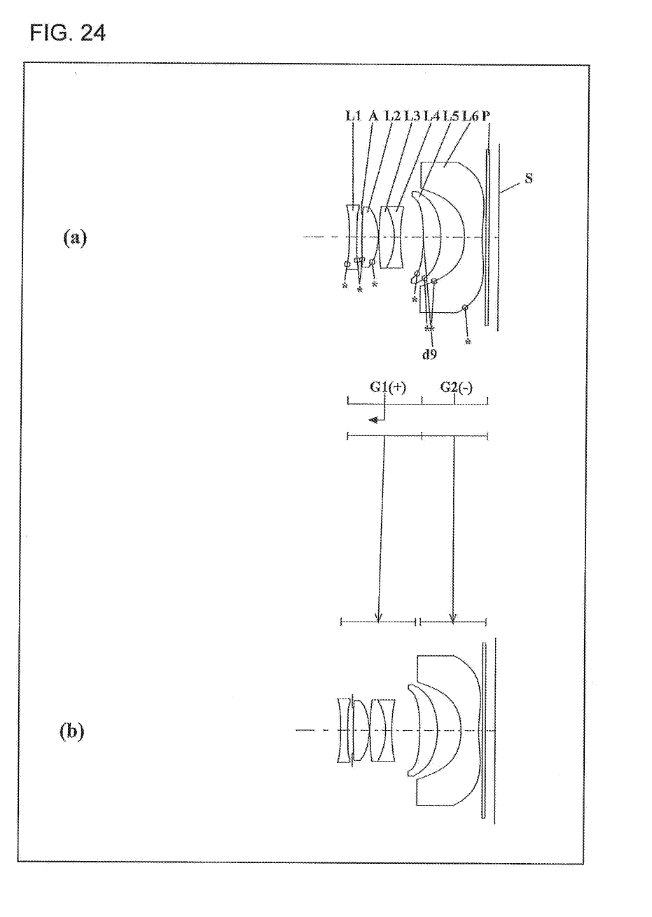

As shown in FIG. 24, a first lens unit G1 has positive optical power, and, in order from the object side to the image side, comprises: a bi-concave first lens element L1; a bi-convex second lens element L2; a bi-convex third lens element L3; and a bi-concave fourth lens element L4. Among these lenses, the third lens element L3 and the fourth lens element L4 are cemented with each other. In the surface data of the corresponding Numerical Example described later, a surface number 7 is imparted to an adhesive layer between the third lens element L3 and the fourth lens element L4.

A second lens unit G2 has negative optical power, and, in order from the object side to the image side, comprises: a positive meniscus fifth lens element L5 with the concave surface facing the object side; and a bi-concave sixth lens element L6.

An aperture diaphragm A is disposed on the image side relative to the first lens element L1, and a parallel plate P is disposed on the object side relative to the image surface S (between the image surface S and the sixth lens element L6).

The both surfaces of the first lens element L1, the both surfaces of the second lens element L2, the both surfaces of the fifth lens element L5; and the both surfaces of the sixth lens element L6 are aspheric surfaces.

In the imaging optical system according to Embodiment IV-2, in focusing from the infinity in-focus condition to the close-object in-focus condition, the first lens unit G1 moves to the object side along the optical axis, and the second lens unit G2 is fixed with respect to the image surface S.

### Embodiment IV-3

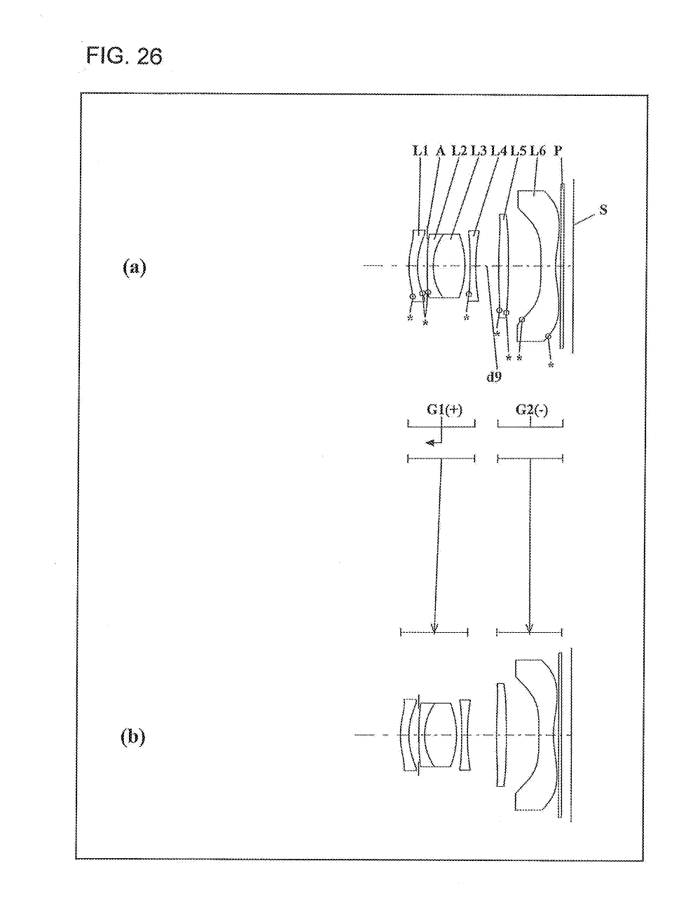

As shown in FIG. 26, a first lens unit G1 has positive optical power, and, in order from the object side to the image side, comprises: a negative meniscus first lens element L1 with the convex surface facing the object side; a negative meniscus second lens element L2 with the convex surface facing the object side; a bi-convex third lens element L3; and a bi-concave fourth lens element L4. Among these lenses, the second lens element L2 and the third lens element L3 are cemented with each other. In the surface data of the corresponding Numerical Example described later, a surface number 5 is imparted to an adhesive layer between the second lens element L2 and the third lens element L3.

A second lens unit G2 has negative optical power, and, in order from the object side to the image side, comprises: a bi-convex fifth lens element L5; and a negative meniscus sixth lens element L6 with the convex surface facing the object side.

An aperture diaphragm A is disposed on the image side relative to the first lens element L1, and a parallel plate P is disposed on the object side relative to the image surface S (between the image surface S and the sixth lens element L6).

The both surfaces of the first lens element L1, the object-side surface of the second lens element L2, the object-side surface of the fourth lens element L4, the both surfaces of the fifth lens element L5, and the both surfaces of the sixth lens element L6 are aspheric surfaces.

In the imaging optical system according to Embodiment IV-3, in focusing from the infinity in-focus condition to the close-object in-focus condition, the first lens unit G1 moves to the object side along the optical axis, and the second lens unit G2 is fixed with respect to the image surface S.

### (V) Embodiment V

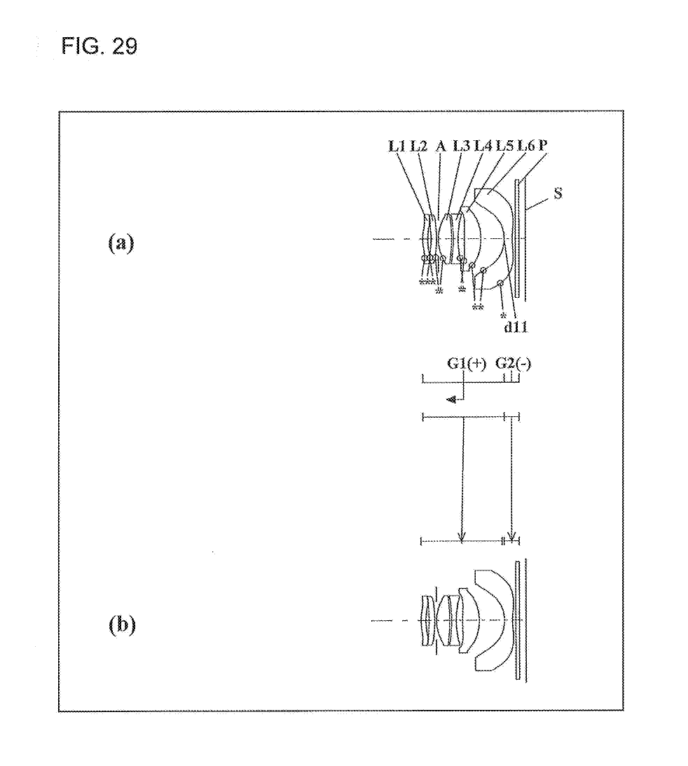

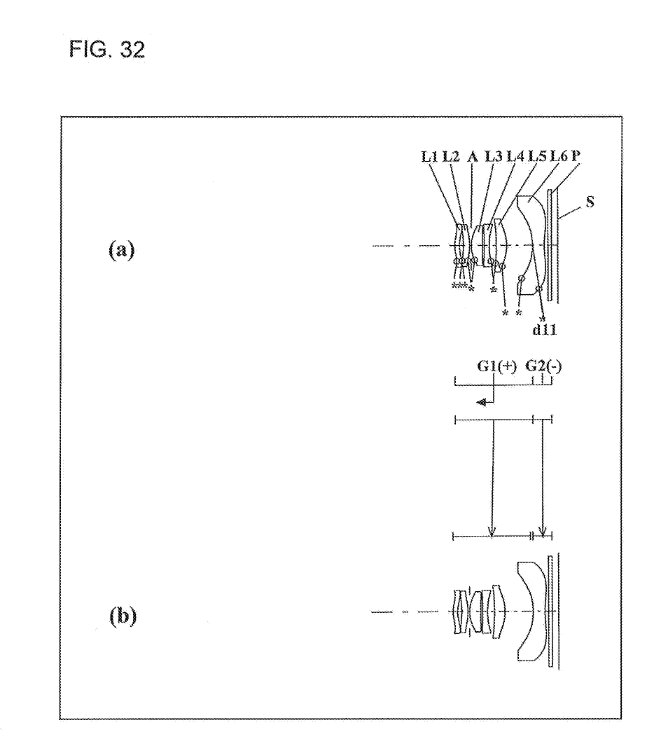

FIGS. 29 and 32 are lens arrangement diagrams of imaging optical systems according to Embodiments V-1 and V-2, in which part (a) shows an infinity in-focus condition and part (b) shows a close-object in-focus condition. In each FIG., an arrow parallel to the optical axis, which is imparted to a lens unit, indicates a moving direction of the lens unit in focusing from the infinity in-focus condition to the close-object in-focus condition. In each FIG., asterisk “*” imparted to a particular surface indicates that the surface is aspheric. In each FIG., symbol (+) or (−) imparted to the symbol of each lens unit corresponds to the sign of the optical power of the lens unit. In each FIG., a straight line located on the most right-hand side indicates the position of the image surface S.

### Embodiment V-1

As shown in FIG. 29, a first lens unit G1 has positive optical power, and, in order from the object side to the image side, comprises: a positive meniscus first lens element L1 with the convex surface facing the object side; a negative meniscus second lens element L2 with the concave surface facing the object side; a bi-convex third lens element L3; a bi-concave fourth lens element L4; and a bi-convex fifth lens element L5.

A second lens unit G2 has negative optical power, and comprises solely a bi-concave sixth lens element L6.

An aperture diaphragm A is disposed on the image side relative to the second lens element L2, and a parallel plate P is disposed on the object side relative to the image surface S (between the image surface S and the sixth lens element L6).

The both surfaces of the first lens element L1, the both surfaces of the second lens element L2, the object-side surface of the third lens element L3, the image-side surface of the fourth lens element L4, the both surfaces of the fifth lens element L5, and the both surfaces of the sixth lens element L6 are aspheric surfaces.

The object-side surface of the first lens element L1 is an aspheric surface, and has an inflection point that changes from the shape convex toward the object side to the shape concave toward the object side as the distance from the optical axis increases. The image-side surface of the first lens element L1 is an aspheric surface, and has an inflection point that changes from the shape convex toward the object side to the shape concave toward the object side as the distance from the optical axis increases. The object-side surface of the fifth lens element L5 is an aspheric surface, and has an inflection point that changes from the shape convex toward the object side to the shape concave toward the object side as the distance from the optical axis increases. The image-side surface of the sixth lens element L6 is an aspheric surface, and has an inflection point that changes from the shape convex toward the object side to the shape concave toward the object side as the distance from the optical axis increases.

As described above, all the inflection points change from the shape convex toward the object side to the shape concave toward the object side as the distance from the optical axis increases.

In the imaging optical system according to Embodiment V-1, in focusing from the infinity in-focus condition to the close-object in-focus condition, the first lens unit G1 moves to the object side along the optical axis, and the second lens unit G2 is fixed with respect to the image surface S.

In addition, the first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

### Embodiment V-2

As shown in FIG. 32, a first lens unit G1 has positive optical power, and, in order from the object side to the image side, comprises: a negative meniscus first lens element L1 with the convex surface facing the object side; a positive meniscus second lens element L2 with the concave surface facing the object side; a positive meniscus third lens element L3 with the convex surface facing the object side; a bi-concave fourth lens element L4; and a positive meniscus fifth lens element L5 with the concave surface facing the object side.

A second lens unit G2 has negative optical power, and comprises solely a bi-concave sixth lens element L6.

An aperture diaphragm A is disposed on the image side relative to the second lens element L2, and a parallel plate P is disposed on the object side relative to the image surface S (between the image surface S and the sixth lens element L6).

The both surfaces of the first lens element L1, the both surfaces of the second lens element L2, the object-side surface of the third lens element L3, the image-side surface of the fourth lens element L4, the both surfaces of the fifth lens element L5, and the both surfaces of the sixth lens element L6 are aspheric surfaces.

The object-side surface of the first lens element L1 is an aspheric surface, and has an inflection point that changes from the shape convex toward the object side to the shape concave toward the object side as the distance from the optical axis increases. The image-side surface of the first lens element L1 is an aspheric surface, and has an inflection point that changes from the shape convex toward the object side to the shape concave toward the object side as the distance from the optical axis increases. The image-side surface of the fifth lens element L5 is an aspheric surface, and has an inflection point that changes from the shape concave toward the object side to the shape convex toward the object side as the distance from the optical axis increases. The image-side surface of the sixth lens element L6 is an aspheric surface, and has an inflection point that changes from the shape convex toward the object side to the shape concave toward the object side as the distance from the optical axis increases.

In the imaging optical system according to Embodiment V-2, in focusing from the infinity in-focus condition to the close-object in-focus condition, the first lens unit G1 moves to the object side along the optical axis, and the second lens unit G2 is fixed with respect to the image surface S.

In addition, the first lens unit G1 moves in the direction perpendicular to the optical axis to optically compensate for image blur. By the first lens unit G1, image point movement caused by vibration of the entire system is compensated for, that is, image blur caused by hand blurring, vibration and the like is optically compensated for.

As described above, Embodiments I to V have been described as examples of the technology disclosed in the present application. However, the technology in the present disclosure is not limited thereto, and is also applicable to embodiments in which changes, substitutions, additions, omissions, and/or the like are made as appropriate.

The following description is given for beneficial conditions that an imaging optical system like the imaging optical systems according to Embodiments I to V can satisfy. Here, a plurality of beneficial conditions are set forth for the imaging optical system according to each embodiment. A construction that satisfies all the plurality of conditions is most effective for the imaging optical system. However, when an individual condition is satisfied, an imaging optical system having the corresponding effect is obtained.

For example, it is beneficial that an imaging optical system like the imaging optical systems according to Embodiments I to V, which comprises, in order from the object side to the image side, a first lens unit having positive optical power and a second lens unit, and in which the first lens unit moves along the optical axis and the second lens unit is fixed with respect to the image surface in focusing from the infinity in-focus condition to the close-object in-focus condition (hereinafter, this lens configuration is referred to as a basic configuration of the embodiments), satisfies the following condition (1):

0.07<L_{G12}/L<0.40 (1)

where

L_{G12} is an axial distance between a most-image-side lens surface of the first lens unit and a most-object-side lens surface of the second lens unit, in the infinity in-focus condition, and

L is an overall lens length showing an axial distance between the most-object-side lens surface of the first lens unit and the image surface, in the infinity in-focus condition.

The condition (1) sets forth the relationship between the overall lens length and the axial distance between the most-image-side lens surface of the first lens unit and the most-object-side lens surface of the second lens unit, that is, the interval between the first lens unit and the second lens unit. When, the condition (1) is satisfied, various aberrations, particularly field curvature, can be satisfactorily compensated for.

When at least one of the following conditions (1)′ and (1)″ is further satisfied, the above-mentioned effect is achieved more successfully.

0.10<L_{G12}/L (1)′

L_{G12}/L<0.30 (1)″

It is beneficial that an imaging optical system having the basic configuration like the imaging optical systems according to Embodiments I to V satisfies the following condition (2):

0.07<BF/Ir<0.40 (2)

where

BF is an axial air conversion distance between a most-image-side lens surface of the second lens unit and the image surface, and

Ir is an image height of an imaging element represented by the following formula:

Ir=f×tan ω

where

f is a focal length of the entire system in the infinity in-focus condition, and

ω is a half view angle in the infinity in-focus condition.

The condition (2) sets forth the relationship between a back focus and the height of the imaging element. When the value goes below the lower limit of the condition (2), it is difficult to secure a required minimum back focus, and a lens element, located closest to the image side, of the second lens unit may physically interfere with a portion of the parallel plate. When the value exceeds the upper limit of the condition (2), the back focus becomes too long with respect to the image height of the imaging element, and the height of a light beam that passes the lens element, located closest to the image side, of the second lens unit is lowered, which makes it difficult to compensate for various aberrations, particularly field curvature. That is, when the condition (2) is satisfied, various aberrations, particularly field curvature, can be satisfactorily compensated for, and an imaging optical system that can be physically established can be further miniaturized.

When at least one of the following conditions (2)′ and (2)″ is further satisfied, the above-mentioned effect is achieved more successfully.

0.10<BF/Ir (2)′

BF/Ir<0.30 (2)″

It is beneficial that an imaging optical system having the basic configuration like the imaging optical systems according to Embodiments I to V satisfies the following condition (3):

0.5<Y′(L−L_{G12})<1.0 (3)

where

Y′ is a maximum image height,

L is the overall lens length showing the axial distance between the most-object-side lens surface of the first lens unit and the image surface, in the infinity in-focus condition, and

L_{G12}, is the axial distance between the most-image-side lens surface of the first lens unit and the most-object-side lens surface of the second lens unit, in the infinity in-focus condition.

The condition (3) sets forth the relationship among the maximum image height, the overall lens length, and the axial distance between the most-image-side lens surface of the first lens unit and the most-object-side lens surface of the second lens unit, that is, the interval between the first lens unit and the second lens unit. When the condition (3) is satisfied, it is possible to realize both satisfactory aberration compensation and miniaturization of the imaging optical system. When the value goes below the lower limit of the condition (3), the value of Y′/(L−L_{G12}) is reduced, and thereby the overall lens length is increased, which makes miniaturization of the imaging optical system difficult. When the value exceeds the upper limit of the condition (3), the value of the Y′/(L−L_{G12}) is increased, and thereby the overall lens length becomes excessively short, which makes realization of satisfactory aberration compensation difficult.

It is beneficial that an imaging optical system like the imaging optical systems according to Embodiments I to V, which has the basic configuration and in which the first lens unit has an aperture diaphragm, satisfies the following condition (4):

0.5<LA/L<1.0 (4)

where

LA is an axial distance from the aperture diaphragm to the image surface, and

L is the overall lens length showing the axial distance between the most-object-side lens surface of the first lens unit and the image surface, in the infinity in-focus condition.

The condition (4) sets forth the ratio between the axial distance from the aperture diaphragm to the image surface and the overall lens length. When the value goes below the lower limit of the condition (4), the aperture diaphragm is too close to the image surface, and a light beam incident on the periphery of the imaging element has no other choice but to pass an area more distant from the optical axis of the lens element located on the object side, such as the first lens element, which makes it difficult to compensate for various aberrations such as spherical aberration, coma aberration, field curvature, and the like. In addition, the position of entrance pupil is also lengthened, and the diameter of the first lens element is increased, which may cause an increase in the size of the imaging optical system. When the value exceeds the upper limit of the condition (4), this means that the aperture diaphragm is located on the object side relative to the surface top of the first lens element. Then, the light beam incident on the periphery of the imaging element has to pass an area more distant from the optical axis of each lens element, which makes it difficult to compensate for various aberrations such as spherical aberration, coma aberration, field curvature, and the like. As a result, it is difficult to obtain a favorable image over the entirety of a screen. That is, when the condition (4) is satisfied, from the center to the periphery of the imaging element, the incident light beam passes from the first lens element to the lens element located closest to the image side, in a well-balanced manner, whereby aberrations can be satisfactorily compensated for over the entirety of the screen, and high resolution can be secured.

When at least one of the following conditions (4)′ and (4)″ is further satisfied, the above-mentioned effect is achieved more successfully.

0.7<LA/L (4)′

LA/L<0.9 (4)″

It is beneficial that an imaging optical system like the imaging optical systems according to Embodiments II, III and V, which has the basic configuration and in which the most-image-side lens surface of the first lens unit has the convex surface facing the image side and the most-object-side lens surface of the second lens unit has the concave surface facing the object side, satisfies the following condition (5):

−1.0<(R_{G1r2}−R_{G2r1})/(R_{G1r2}+R_{G2r1})<0.0 (5)

where

R_{G1r2} is a radius of curvature of the most-image-side lens surface of the first lens unit, and

R_{G2r1} is a radius of curvature of the most-object-side lens surface of the second lens unit.

The condition (5) sets forth the relationship between the radius of curvature of the most-image-side lens surface of the first lens unit and the radius of curvature of the most-object-side lens surface of the second lens unit. When the condition (5) is satisfied, it is possible to satisfy both satisfactory aberration compensation and miniaturization of the imaging optical system in the non-used state. When the value goes below the lower limit of the condition (5), the value of (R_{G1r2}−R_{G2r1})/(R_{G1r2}+R_{G2r1}) is reduced, and the value of R_{G1r2} is reduced, which makes it difficult to realize satisfactory aberration compensation. When the value exceeds the upper limit of the condition (5), the value of (R_{G1r2}−R_{G2r1})/(R_{G1r2}+R_{G2r1}) is increased, and the value of R_{G1r2} becomes larger than the value of R_{G2r1}, which makes it difficult to realize the configuration to reduce the overall lens length in the non-used state.

It is beneficial that an imaging optical system like the imaging optical systems according to Embodiments I to III, which has the basic configuration and in which the first lens unit, in order from the object side to the image side, comprises the first lens element having negative optical power and at least one subsequent lens element, satisfies the following condition (6):

0.5<|f_{L1}/f|<5.0 (6)

where

f_{L1} is a focal length of the first lens element in the infinity in-focus condition, and

f is the focal length of the entire system in the infinity in-focus condition.

The condition (6) sets forth the relationship between the focal length of the first lens element and the focal length of the entire imaging optical system. When the condition (6) is satisfied, it is possible to realize both satisfactory aberration compensation and a wider view angle of the imaging optical system. When the condition (6) is not satisfied, it may become difficult to compensate for aberrations such as field curvature, astigmatism, distortion and the like. When the value goes below the lower limit of the condition (6), the value of |f_{L11}/f| is reduced, and thereby the optical power of the first lens element is increased, which makes it difficult to realize satisfactory aberration compensation. When the value exceeds the upper limit of the condition (6), the value of |f_{L11}/f| is increased, and thereby the optical power of the first lens element is reduced, which makes it difficult to achieve a wider view angle of the imaging optical system. It is more beneficial that the condition (6) is satisfied in the imaging optical system in which the first lens element having negative optical power has the concave surface facing the object side, like the imaging optical systems according to Embodiments I to III.

When at least one of the following conditions (6)′ and (6)″ is further satisfied, the above-mentioned effect is achieved more successfully.

2.0<|f_{L1}/f| (6)′

|f_{L1}/f|<4.0 (6)″

It is beneficial that an imaging optical system having the basic configuration like the imaging optical systems according to Embodiments I to V satisfies the following condition (7):

−1.0<f_{G1}/f_{G2}<−0.3 (7)

where

f_{G1} is a composite focal length of the first lens unit in the infinity in-focus condition, and

f_{G2} is a composite focal length of the second lens unit in the infinity in-focus condition.

The condition (7) sets forth the relationship between the composite focal length of the first lens unit and the composite focal length of the second lens unit. When the condition (7) is not satisfied, it is difficult to compensate for aberrations such as field curvature, astigmatism, distortion and the like.

It is beneficial that an imaging optical system like the imaging optical systems according to Embodiments I and III, which has the basic configuration and in which the first lens unit, in order from the object side to the image side, comprises the first lens element having negative optical power, the aperture diaphragm, the second lens element having positive optical power, the third lens element having negative optical power, and the fourth lens element having positive optical power, satisfies the following condition (8):

1.0<f_{L4}/f<3.0 (8)

where

f_{L4} is a focal length of the fourth lens element in the infinity in-focus condition, and

f is the focal length of the entire system in the infinity in-focus condition.

The condition (8) sets forth the relationship between the focal length of the fourth lens element and the focal length of the entire imaging optical system. When the condition (8) is not satisfied, it is difficult to compensate for astigmatism, distortion and the like.

It is beneficial that an imaging optical system having the basic configuration like the imaging optical systems according to Embodiments I to III and V satisfies the following condition (9):

0.5<Lₘᵢₙ/L<0.8 (9)

where

Lₘᵢₙ is a minimum overall lens length showing an axial distance between the most-object-side lens surface of the first lens unit and the image surface, in the non-used state, and

L is the overall lens length showing the axial distance between the most-object-side lens surface of the first lens unit and the image surface, in the infinity in-focus condition:

The condition (9) sets forth the relationship between the minimum overall lens length in the non-used state and the overall lens length in the infinity in-focus condition. When the condition (9) is satisfied, it is possible to realize both excellent optical performance and miniaturization of the imaging optical system. When the value goes below the lower limit of the condition (9), the value of Lₘᵢₙ/L is reduced, and thereby it is difficult to realize excellent optical performance although miniaturization of the imaging optical system is realized. When the value exceeds the upper limit of the condition (9), the value of Lₘᵢₙ/L is increased, and thereby the effect of achieving miniaturization of the imaging optical system is degraded.

It is beneficial that an imaging optical system having the basic configuration like the imaging optical system according to Embodiment IV satisfies the following condition (10):

f_{G1Li}/f<0.0 (10)

where

f_{G1Li} is a focal length of a lens element closest to the image side in the first lens unit, in the infinity in-focus condition, and

f is the focal length of the entire system in the infinity in-focus condition.

The condition (10) sets forth the relationship between the focal length of the lens element closest to the image side in the first lens unit and the focal length of the entire imaging optical system. When the value exceeds the upper limit of the condition (10), the focal length of the lens element closest to the image side in the first lens unit becomes excessively strong in the positive direction, which makes it difficult to compensate for various aberrations, particularly field curvature. When the condition (10) is satisfied, the light beam traveling from the first lens unit to the second lens unit can be swung up, and thus further miniaturization of the imaging optical system can be realized.

When at least one of the following conditions (10)′ and (10)″ is further satisfied, the above-mentioned effect is achieved more successfully.

f_{G1Li}/f<−0.2 (10)′

−3.0<f_{G1Li}/f (10)″

It is beneficial that an imaging optical system having the basic configuration like the imaging optical systems according to Embodiments I, III and IV satisfies the following condition (11):

−1.0<Ir/R_{G1r2} (11)

where

Ir is the image height of the imaging element represented by the following formula:

Ir=f×tan ω

where

f is the focal length of the entire system in the infinity in-focus condition, and

ω is the half view angle in the infinity in-focus condition, and

R_{G1r2} is a radius of curvature of the most-image-side lens surface of the first lens unit.

The condition (11) sets forth the relationship between the image height of the imaging element and the radius of curvature of the most-image-side lens surface of the first lens unit. When the condition (11) is satisfied, various aberrations, particularly field curvature, can be satisfactorily compensated. Further, the light beam traveling from the first lens unit to the second lens unit can be swung up, and thus further miniaturization of the imaging optical system can be realized.

When at least one of the following conditions (11)′ and (11)″ is further satisfied, the above-mentioned effect is achieved more successfully.

Ir/R_{G1r2}<3.0 (11)′

0.0<R_{G1r2} (11)″

In an imaging optical system having the basic configuration like the imaging optical systems according to Embodiments I to V, it is beneficial that at least one lens element constituting the imaging optical system satisfies the following condition (12):

nd+0.0025×vd−1.7125<0.0 (12)

where

nd is a refractive index to the d-line of each lens element constituting the imaging optical system, and

vd is an Abbe number to the d-line of each lens element constituting the imaging optical system.

The condition (12) sets forth the relationship between the refractive index and the Abbe number of each lens element. When the value exceeds the upper limit of the condition (12), the Abbe number is excessively increased with respect to a desired refractive index, which makes it difficult to compensate for various aberrations, particularly color aberration. It is more beneficial that the lens element located closest to the object side among the lens elements constituting the imaging optical system satisfies the condition (12) like the imaging optical systems according to Embodiments I to V, and it is still more beneficial that all the lens elements constituting the imaging optical system satisfy the condition (12) like the imaging optical system according to Embodiment V.

In the imaging optical system according to any of Embodiments I to V, the first lens unit, in order from the object side to the image side, comprises the first lens element having negative optical power, and at least one subsequent lens element. Therefore, it is possible to reduce the overall lens length and make the imaging optical system compact, while achieving a wide view angle and higher performance.

In the imaging optical system according to any of Embodiments I to V, the first lens unit, in order from the object side to the image side, comprises the first lens element having negative optical power, and at least one subsequent lens element, and the second lens element located closest to the object side among the subsequent lens elements has positive optical power. Therefore, the first lens unit can be miniaturized, and the angle of a light beam incident on the imaging element can be reduced with respect to the optical axis.

In the imaging optical system according to any of Embodiments I to V, the first lens unit, in order from the object side to the image side, comprises the first lens element, and at least one subsequent lens element, and the sign of the optical power of the second lens element located closest to the object side among the subsequent lens elements is opposite to the sign of the optical power of the first lens element. Therefore, various aberrations that occur in the first lens element can be canceled out each other at the close positions, thereby realizing satisfactory aberration compensation over the entire system.

In the imaging optical system according to any of Embodiments I to V, the first lens unit includes the aperture diaphragm. Therefore, even the compact imaging optical system can achieve excellent resolution performance.

In the case where the first lens element has the convex surface facing the object side as in the imaging optical systems according to Embodiments II, IV and V, an angle formed between the light beam incident on the peripheral part of the first lens element and the lens surface is approximately a right angle. Therefore, it is not necessary to perform excessive aberration compensation in the first lens element, thereby realizing satisfactory aberration compensation over the entire system.

In the case where the first lens element has an aspheric object-side surface and has an inflection point that changes from the convex shape to the concave shape as the distance from the optical axis increases as in the imaging optical system according to Embodiment V, various aberrations, particularly field curvature, can be satisfactorily compensated for, and the performance from the center of the screen to the periphery can be improved.

In the imaging optical system according to any of Embodiments I to V, since at least six lens surfaces among all the lens surfaces of the lens elements constituting the imaging optical system are aspheric surfaces, various aberrations can be satisfactorily compensated for. It is more beneficial that at least eight lens surfaces among all the lens surfaces of the lens elements constituting the imaging optical system are aspheric surfaces, as in the imaging optical systems according to Embodiments IV and V.

In the imaging optical system according to any of Embodiments I to V, at least one of the lens elements constituting the imaging optical system is made of a resin material, reduction in weight of the imaging optical system can be achieved. It is more beneficial that all the lens elements constituting the imaging optical system are made of a resin material as in the imaging optical system according to Embodiment V.

For example, in the case where all the lens elements constituting the imaging optical system are single lens elements and no composite lens element is included in the imaging optical system as in the imaging optical system according to Embodiment V, occurrence of various aberrations and reduction in performance caused by distortion of lens elements, which will be a problem when soft lens elements such as lens elements made of a resin are cemented with each other, can be avoided, thereby maintaining high resolution.

In the case where the lens element located closest to the image side in the imaging optical system has negative optical power and the second lens element from the image side has positive optical power as in the imaging optical systems according to Embodiments I, II, IV and V, various aberrations, particularly field curvature, that occur in the second lens element from the image side can be compensated for by the lens element located closest to the image side, whereby high resolution performance can be realized even at the periphery of the screen.

In the case where the second lens unit is composed of a single lens element as in the imaging optical systems according to Embodiments I, II and V, since the number of the lens elements constituting the second lens unit which is particularly large in size among the lens unit constituting the imaging optical system is reduced to the minimum number, further miniaturization of the optical system can be realized.

The imaging optical system according to any of Embodiments I to V includes an image blur compensating lens unit that moves in the direction perpendicular to the optical axis in order to move the position of the image in the direction perpendicular to the optical axis, and the first lens unit corresponds to the image blur compensating lens unit. By the image blur compensating lens unit, image point movement caused by vibration of the entire system is compensated for, that is, image blur caused by hand blurring, vibration and the like is optically compensated for.

When the image point movement caused by vibration of the entire system is compensated for, the image blur compensating lens unit moves in the direction perpendicular to the optical axis as described above, whereby compensation for image blur can be performed in the state that increase in the size of the entire imaging optical system is suppressed to realize a compact configuration and that excellent imaging characteristics such as small decentering coma aberration and small decentering astigmatism are maintained

In the imaging optical system according to any of Embodiments I to V, the image blur compensating lens unit is a single lens unit. However, in the case where one lens unit is composed of a plurality of lens elements, the image blur compensating lens unit may be any one lens element or a plurality of adjacent lens elements among the plurality of lens elements.

Each of the lens units constituting the imaging optical system according to any of Embodiments I to V is composed exclusively of refractive type lens elements that deflect the incident light by refraction (that is, lens elements of a type in which deflection is performed at the interface between mediums having different refractive indices). However, the present disclosure is not limited to this. For example, the lens units may employ: diffractive type lens elements that deflect the incident light by diffraction; refractive-diffractive hybrid type lens elements that deflect the incident light by a combination of diffraction and refraction; or gradient index type lens elements that deflect the incident light by distribution of refractive index in the medium. In particular, in the refractive-diffractive hybrid type lens elements, when a diffraction structure is formed at the interface between mediums having different refractive indices, wavelength dependence of the diffraction efficiency is improved.

Each of the lens elements constituting the imaging optical system according to any of Embodiments I to V may be a hybrid lens obtained by cementing a transparent resin layer made of a ultraviolet curable resin onto one surface of a lens element made of glass. In this case, since the optical power of the transparent resin layer is low, the transparent resin layer cemented with the lens element made of glass is regarded as one lens element. Likewise, also when a lens element which is substantially a flat plate is arranged, since the optical power of the flat-plate-like lens element is low, this lens element is not regarded as one lens element.

(Embodiment of Mobile Terminal)

(I) Mobile Terminal to which Imaging Optical System According to Embodiment I-1 is Applied

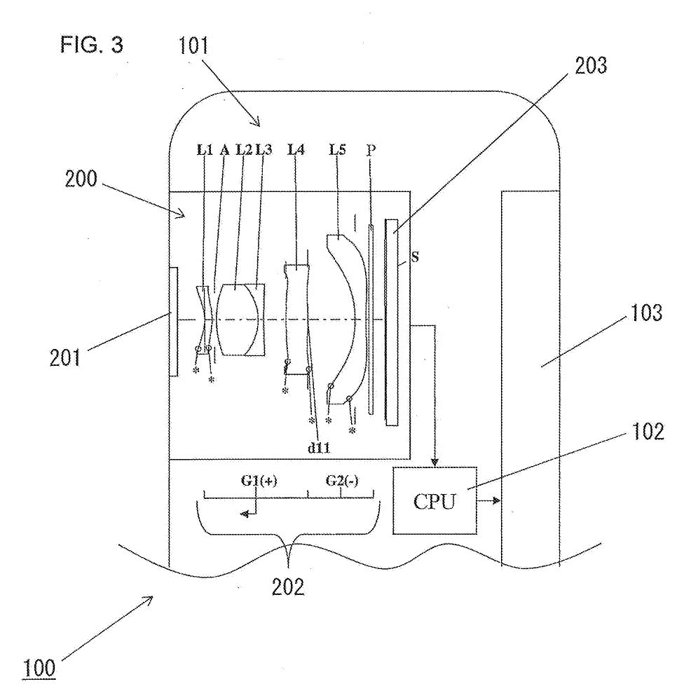

FIG. 3 is a schematic structural diagram of a mobile terminal to which the imaging optical system according to Embodiment I-1 is applied.

The mobile terminal 100 includes a mobile terminal body 101, a CPU 102, a monitor 103, and an optical module 200.

The optical module 200 includes a transparent cover 201, an imaging optical system 202, and an imaging element 203.

The imaging element 203 receives an optical image formed by the imaging optical system 202, and converts the optical image into an electric image signal. The CPU 102 obtains the image signal, and outputs the image signal to the monitor 103. The monitor 103 displays the image signal.

While an example in which the imaging optical system according to Embodiment I-1 is applied to the mobile terminal such as a smartphone is described above, the imaging optical system according to Embodiment I-1 is also applicable to a monitor camera in a monitor system, a Web camera, an in-vehicle camera, and the like.

(II) Mobile Terminal to which Imaging Optical System According to Embodiment II-1 is Applied

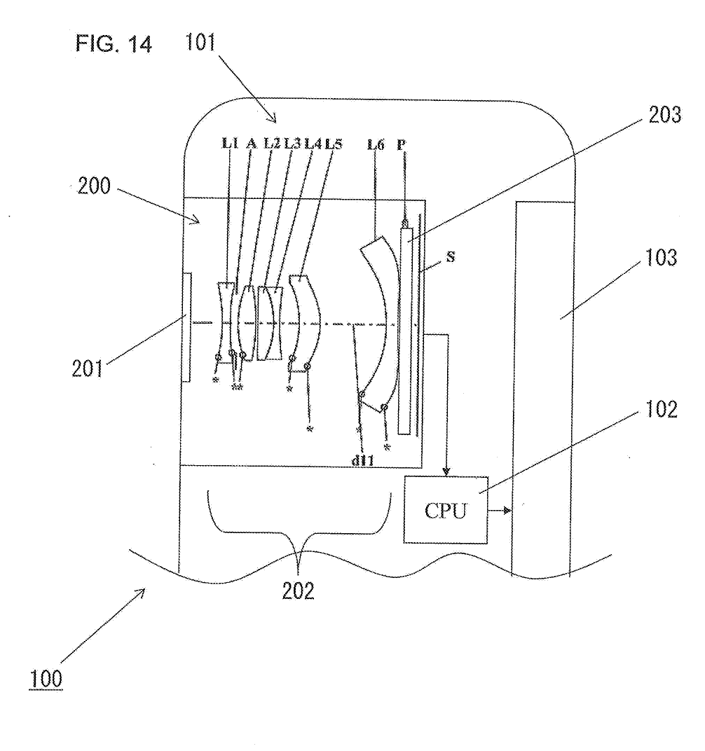

FIG. 14 is a schematic structural diagram of a mobile terminal to which the imaging optical system according to Embodiment II-1 is applied.

The mobile terminal 100 includes a mobile terminal body 101, a CPU 102, a monitor 103, and an optical module 200.

The optical module 200 includes a transparent cover 201, an imaging optical system 202, and an imaging element 203.

The imaging element 203 receives an optical image formed by the imaging optical system 202, and converts the optical image into an electric image signal. The CPU 102 obtains the image signal, and outputs the image signal to the monitor 103. The monitor 103 displays the image signal.

While an example in which the imaging optical system according to Embodiment II-1 is applied to the mobile terminal such as a smartphone is described above, the imaging optical systems according to Embodiments II-2 to II-5 may be used instead of the imaging optical system according to Embodiment II-1. Further, the imaging optical systems according to Embodiments II-1 to II-5 are also applicable to a monitor camera in a monitor system, a Web camera, an in-vehicle camera, and the like.

(III) Mobile Terminal to which Imaging Optical System According to Embodiment III-1 is Applied

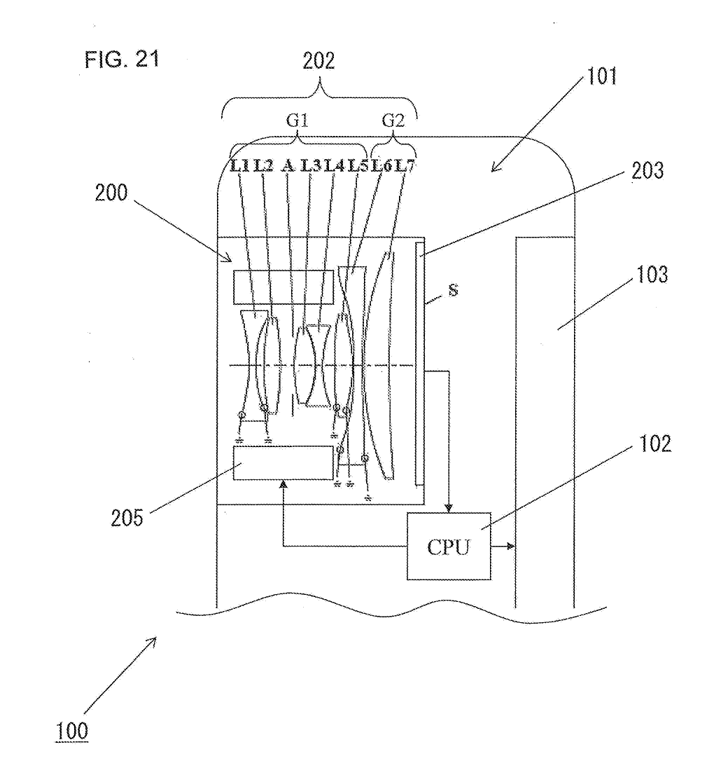

FIG. 21 is a schematic structural diagram of a mobile terminal to which the imaging optical system according to Embodiment III-1 is applied. In the mobile terminal shown in FIG. 21, the imaging optical system 202 is in its non-used state.

The mobile terminal 100 includes a mobile terminal body 101, a CPU 102, a monitor 103, and an optical module 200.

The optical module 200 includes an imaging optical system 202 and an imaging element 203.

In the imaging optical system 202, the first lens unit G1 is allowed to move from the non-used state to the infinity in-focus condition, and from the infinity in-focus condition to the close-object in-focus condition, by a retraction/focusing mechanism 205. The retraction/focusing mechanism 205 can be implemented by an actuator, a mechanical component, and the like. The retraction/focusing mechanism 205 moves the first lens unit G1 in response to a control signal from the CPU 102.

The imaging element 203 receives an optical image formed by the imaging optical system 202, and converts the optical image into an electric image signal. The CPU 102 obtains the image signal, and outputs the image signal to the monitor 103. The monitor 103 displays the image signal.

While an example in which the imaging optical system according to Embodiment III-1 is applied to the mobile terminal such as a smartphone is described above, the imaging optical systems according to Embodiments III-2 and III-3 may be used instead of the imaging optical system according to Embodiment III-1. Further, the imaging optical systems according to Embodiments III-1 to III-3 are also applicable to a monitor camera in a monitor system, a Web camera, an in-vehicle camera, and the like.

(IV) Mobile Terminal to which Imaging Optical System According to Embodiment IV-1 is Applied

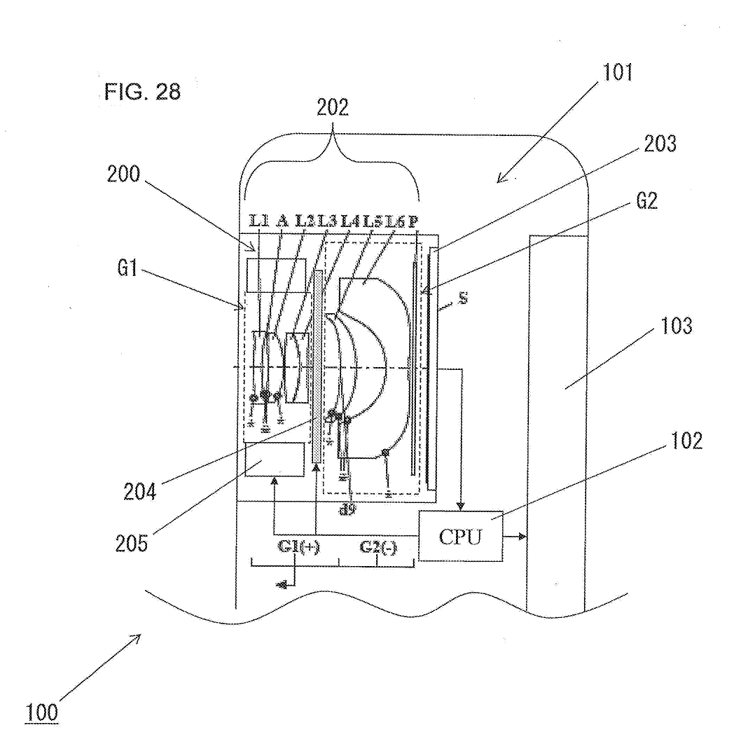

FIG. 28 is a schematic structural diagram of a mobile terminal to which the imaging optical system according to Embodiment IV-1 is applied.

The mobile terminal 100 includes a mobile terminal body 101, a CPU 102, a monitor 103, and an optical module (lens barrel) 200.

The optical module 200 includes an imaging optical system 202, an imaging element 203, and a mechanical shutter unit 204.

In the imaging optical system 202, the first lens unit G1 is allowed to move from the infinity in-focus condition to the close-object in-focus condition by a focusing mechanism 205. The focusing mechanism 205 can be implemented by an actuator, a mechanical component, and the like. The focusing mechanism 205 moves the first lens unit G1 in response to a control signal from the CPU 102.

The mechanical shutter unit 204 is disposed between the first lens unit G1 and the second lens unit G2. In the imaging optical system according to Embodiment IV-1, a space for the mechanical shutter unit 204 is secured between the first lens unit G1 and the second lens unit G2. Therefore, further miniaturization of the optical module 200 is possible. The mechanical shutter unit 204 is driven in accordance with a control signal from the CPU 102.

The imaging element 203 receives an optical image formed by the imaging optical system 202, and converts the optical image into an electric image signal. The CPU 102 obtains the image signal, and outputs the image signal to the monitor 103. The monitor 103 displays the image signal.

While an example in which the imaging optical system according to Embodiment IV-1 is applied to the mobile terminal such as a smartphone is described above, the imaging optical systems according to Embodiments IV-2 to IV-3 may be used instead of the imaging optical system according to Embodiment IV-1. Further, the imaging optical systems according to Embodiments IV-1 to IV-3 are also applicable to a monitor camera in a monitor system, a Web camera, an in-vehicle camera, and the like.

(V) Mobile Terminal to which Imaging Optical System According to Embodiment V-1 is Applied

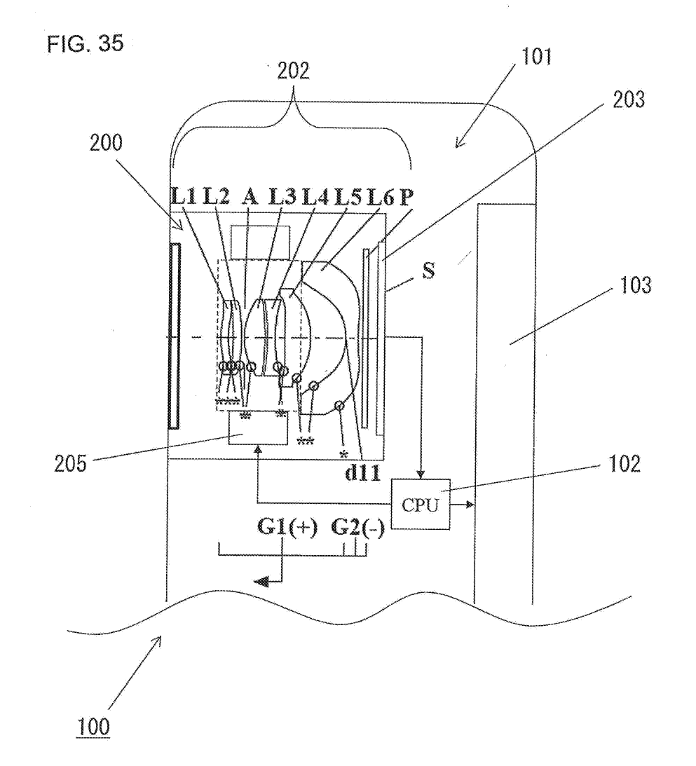

FIG. 35 is a schematic structural diagram of a mobile terminal to which the imaging optical system according to Embodiment V-1 is applied.

The mobile terminal 100 includes a mobile terminal body 101, a CPU 102, a monitor 103, and an optical module (lens barrel) 200.

The optical module 200 includes an imaging optical system 202 and an imaging element 203.

In the imaging optical system 202, the first lens unit G1 is allowed to move from the infinity in-focus condition to the close-object in-focus condition by the focusing mechanism 205. The focusing mechanism 205 can be implemented by an actuator, a mechanical component, and the like. The focusing mechanism 205 moves the first lens unit G1 in response to a control signal from the CPU 102.

The imaging element 203 receives an optical image formed by the imaging optical system 202, and converts the optical image into an electric image signal. The CPU 102 obtains the image signal, and outputs the image signal to the monitor 103. The monitor 103 displays the image signal.

While an example in which the imaging optical system according to Embodiment V-1 is applied to the mobile terminal such as a smartphone is described above, the imaging optical system according to Embodiment V-2 may be used instead of the imaging optical system according to Embodiment V-1. Further, the imaging optical systems according to Embodiments V-1 and V2 are also applicable to a monitor camera in a monitor system, a Web camera, an in-vehicle camera, and the like.

As presented above, the embodiments have been described as examples of the art disclosed in the present application. However, the art in the present disclosure is not limited to this embodiment. It is understood that various modifications, replacements, additions, omissions, and the like have been performed in these embodiments to give optional embodiments, and the art in the present disclosure can be applied to the optional embodiments.

The following description is given for numerical examples in which the imaging optical systems according to Embodiments I to V are implemented practically. In the numerical examples, the units of the length in the tables are all “mm”, and the units of the view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspheric surfaces, and the aspheric surface configuration is defined by the following expression:

$$Z = \frac{{h}^{2} / r}{1 + \sqrt{1 - ( 1 + κ ) {( h / r )}^{2}}} + \sum {A}_{n} {h}^{n}$$

where

Z is the distance from a point on an aspherical surface at a height h relative to the optical axis to a tangential plane at the vertex of the aspherical surface,

h is the height relative to the optical axis,

r is the radius of curvature at the top,

κ is the conic constant, and

Aₙ is the n-th order aspherical coefficient.

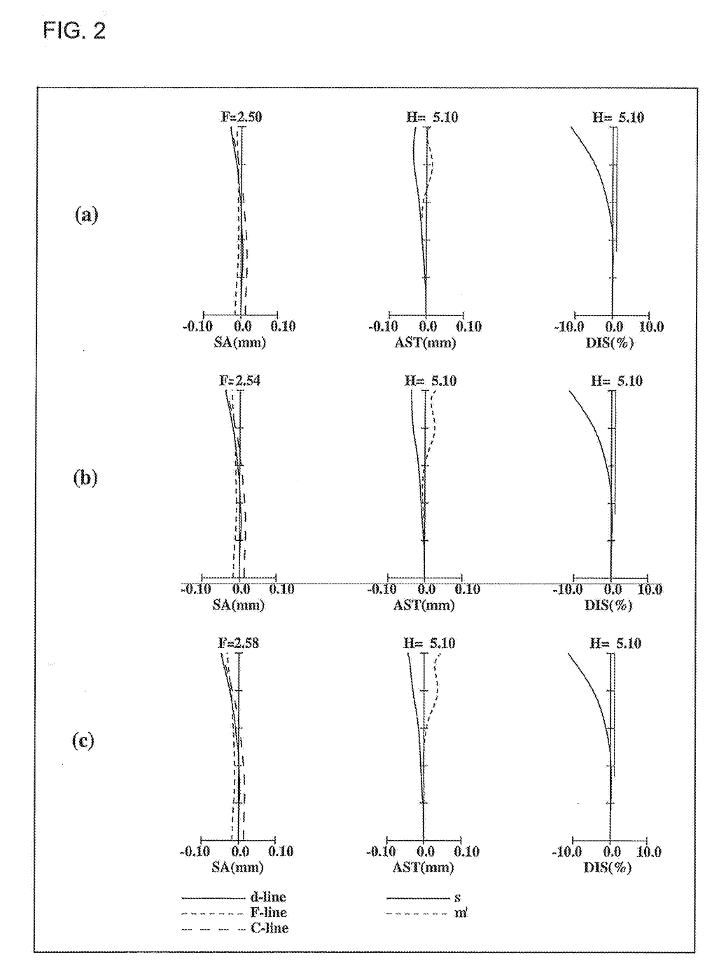

FIG. 2 is a longitudinal aberration diagram of the imaging optical system according to Numerical Example I-1, in which part (a) shows a longitudinal aberration diagram in the infinity in-focus condition, part (b) shows a longitudinal aberration diagram in the in-focus condition (close-object in-focus condition) at an object point distance of 30 cm, and part (c) shows a longitudinal aberration diagram in the in-focus condition (close-object in-focus condition) at an object point distance of 15 cm.

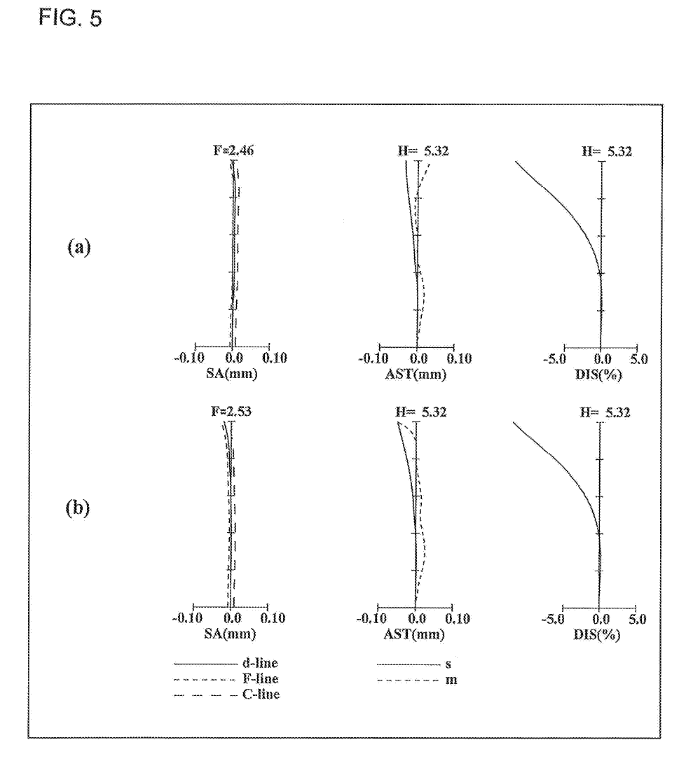

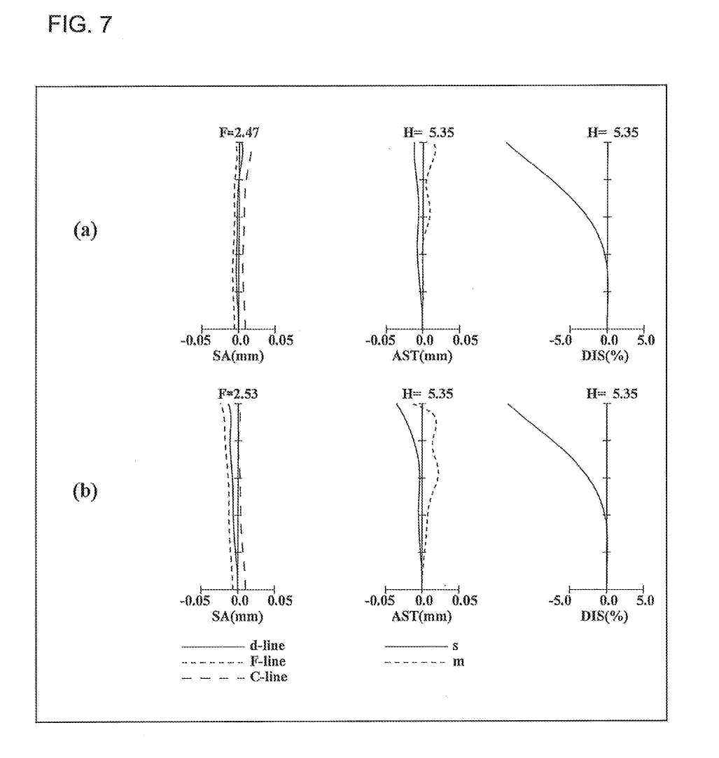

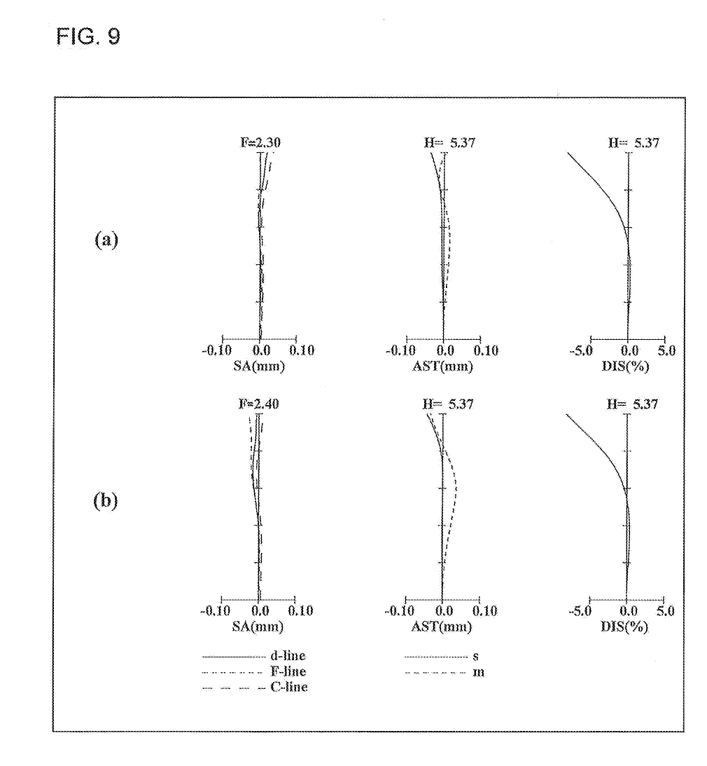

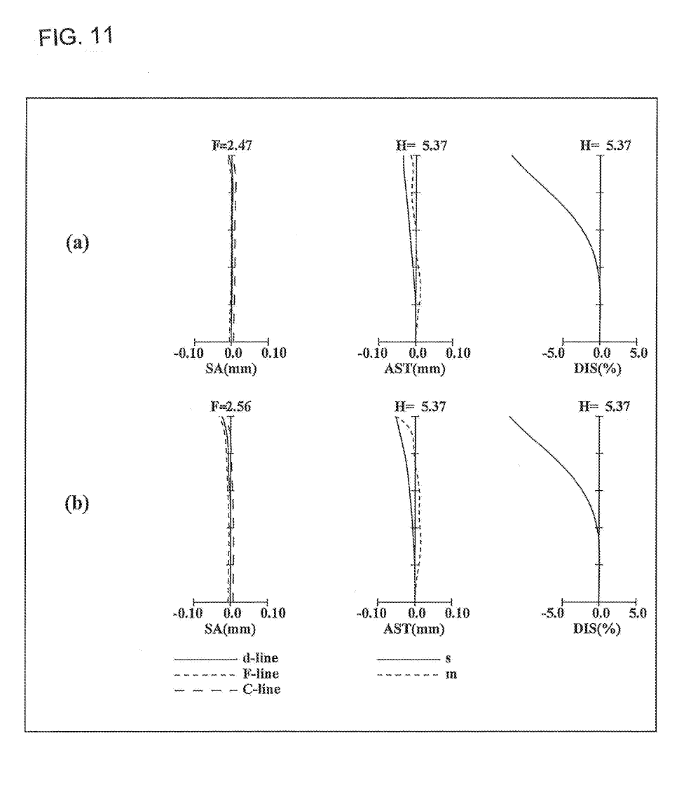

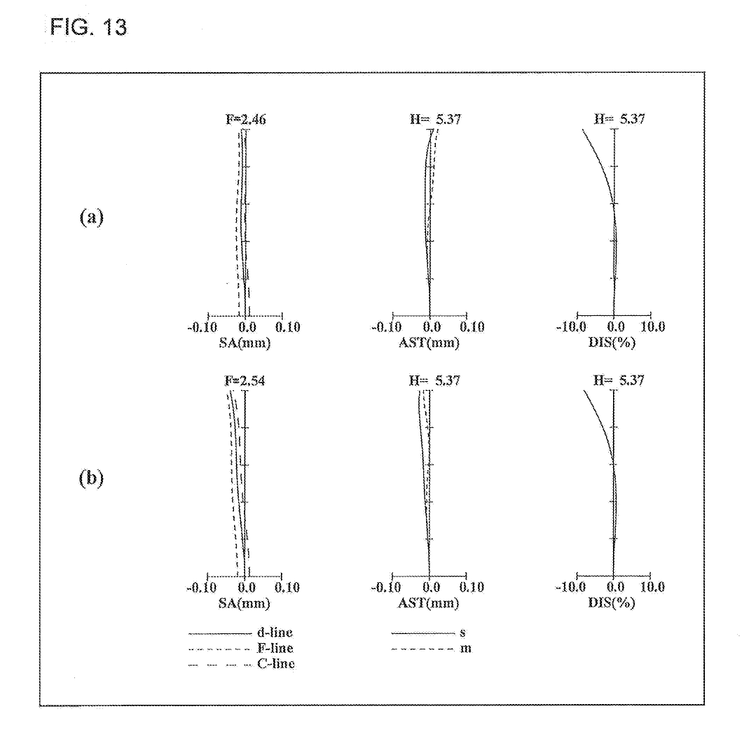

FIGS. 5, 7, 9, 11 and 13 are longitudinal aberration diagrams of the imaging optical systems according to Numerical Examples II-1 to II-5. In each FIG., part (a) shows a longitudinal aberration diagram in the infinity in-focus condition, and part (b) shows a longitudinal aberration diagram in the in-focus condition (close-object in-focus condition) at an object point distance of 15 cm.

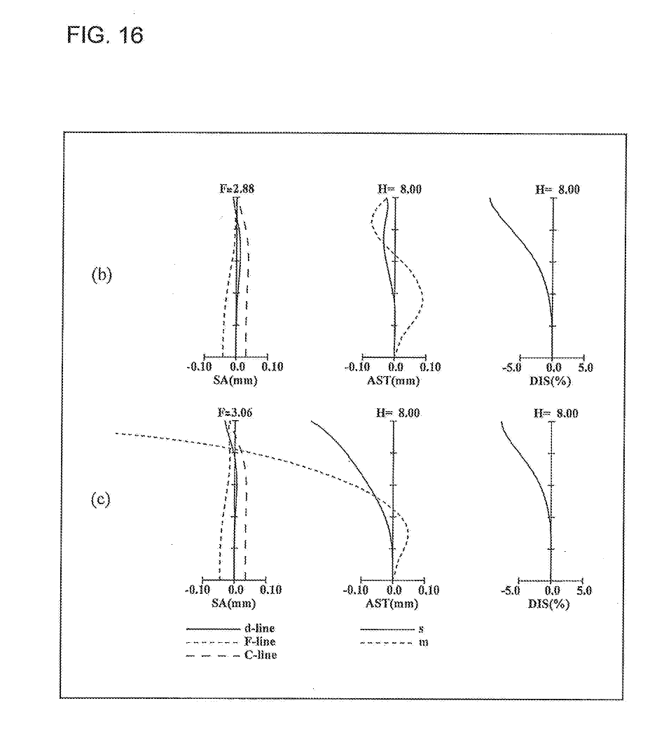

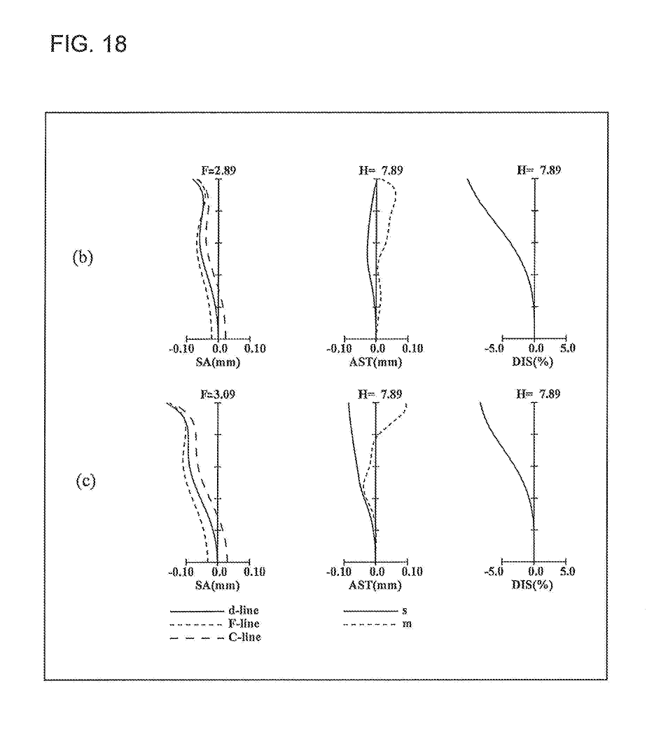

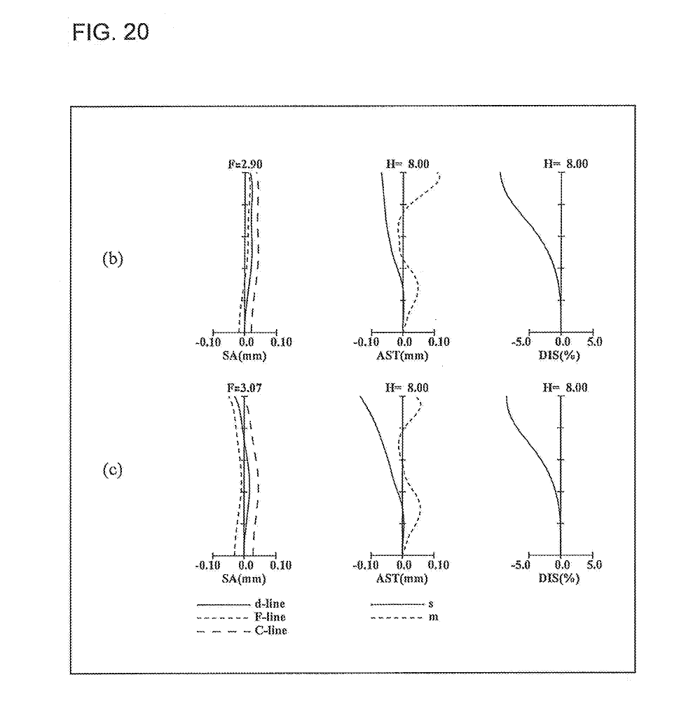

FIGS. 16, 18, and 20 are longitudinal aberration diagrams of the imaging optical systems according to Numerical Examples III-1 to III-3. In each FIG., part (b) shows a longitudinal aberration diagram in the infinity in-focus condition, and part (c) shows a longitudinal aberration diagram in the in-focus state (close-object in-focus condition) at the nearest-end (Numerical Example III-1: object point distance of 15 cm, Numerical Example III-2: object point distance of 10 cm, Numerical Example III-3: object point distance of 10 cm).

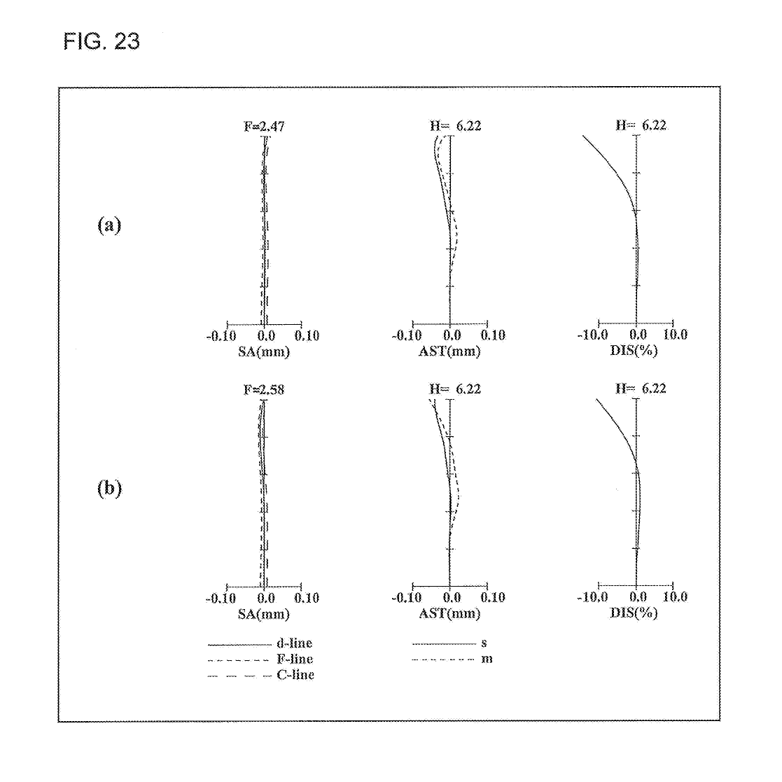

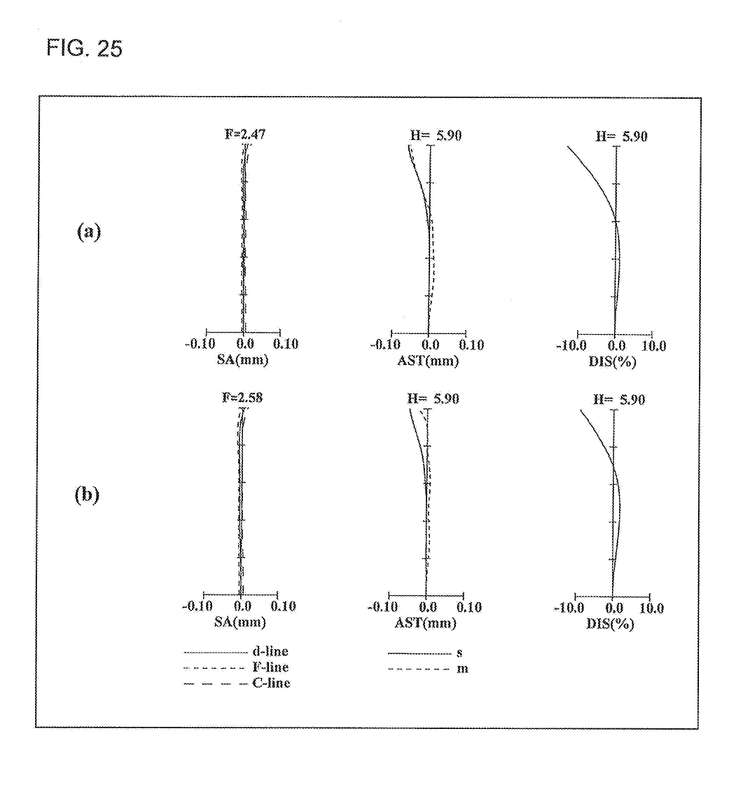

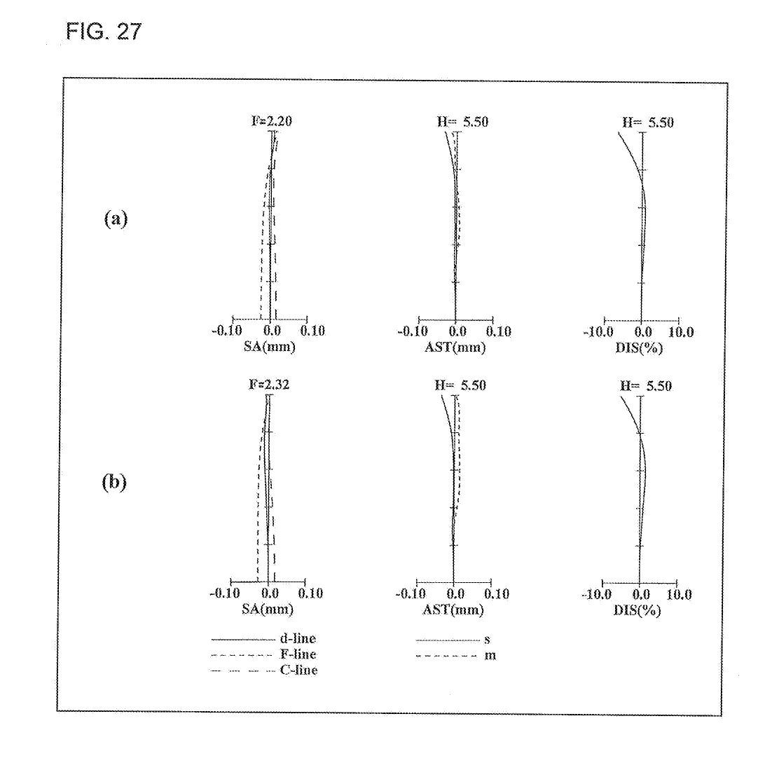

FIGS. 23, 25 and 27 are longitudinal aberration diagrams of the imaging optical systems according to Numerical Examples IV-1 to IV-3. In each FIG., part (a) shows a longitudinal aberration diagram in the infinity in-focus condition, and part (b) shows a longitudinal aberration diagram in the in-focus condition (close-object in-focus condition) at an object point distance of 15 cm.

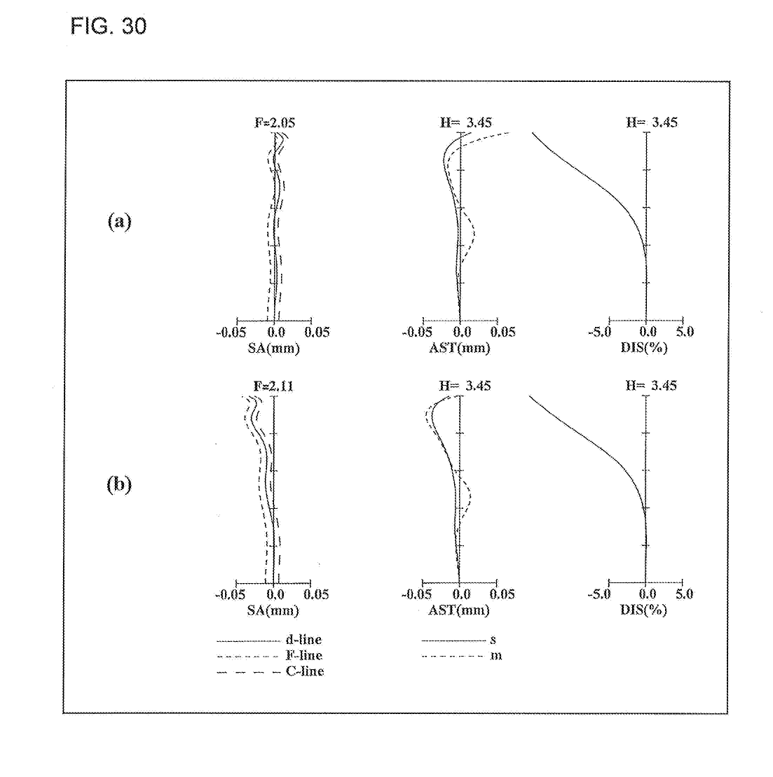

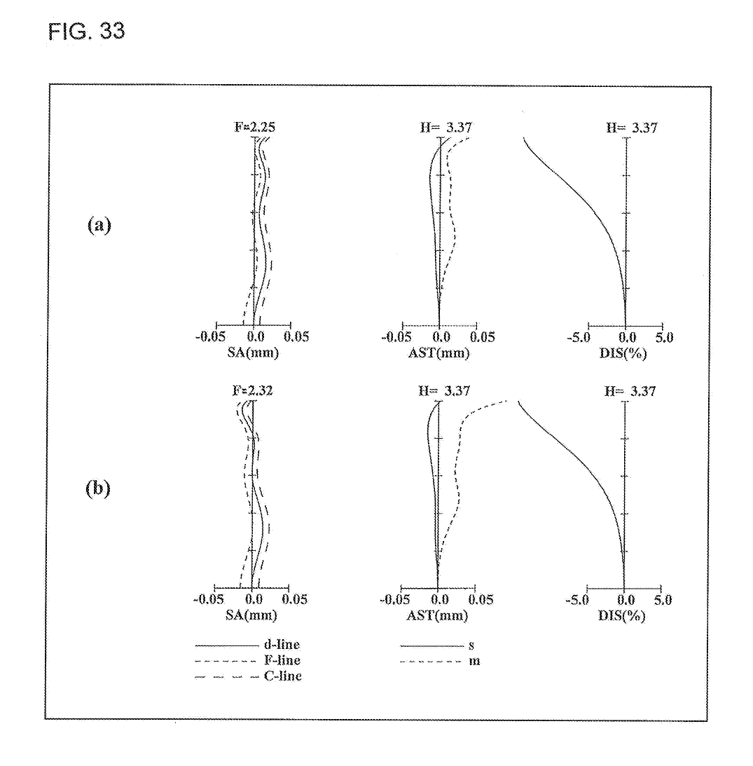

FIGS. 30 and 33 are longitudinal aberration diagrams of the imaging optical systems according to Numerical Examples V-1 and V-2. In each FIG., part (a) shows a longitudinal aberration diagram in the infinity in-focus condition, and part (b) shows a longitudinal aberration diagram in the in-focus condition (close-object in-focus condition) at an object point distance of 10 cm.

Each longitudinal aberration diagram, in order from the left-hand side, shows the spherical aberration (SA (mm)), the astigmatism (AST (mm)), and the distortion (DIS (%)). In each spherical aberration diagram, the vertical axis indicates the F-number (in each FIG., indicated as F), and the solid line, the short dash line, and the long dash line indicate the characteristics to the d-line, the F-line, and the C-line, respectively. In each astigmatism diagram, the vertical axis indicates the image height (in each FIG., indicated as H), and the solid line and the dash line indicate the characteristics to the sagittal plane (in each FIG., indicated as “s”) and the meridional plane (in each FIG., indicated as “m”), respectively. In each distortion diagram, the vertical axis indicates the image height (in each FIG., indicated as H).

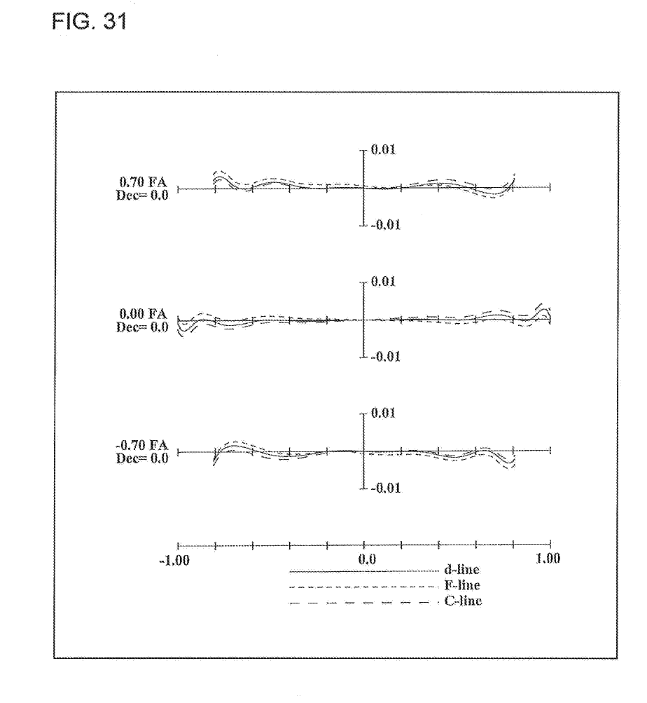

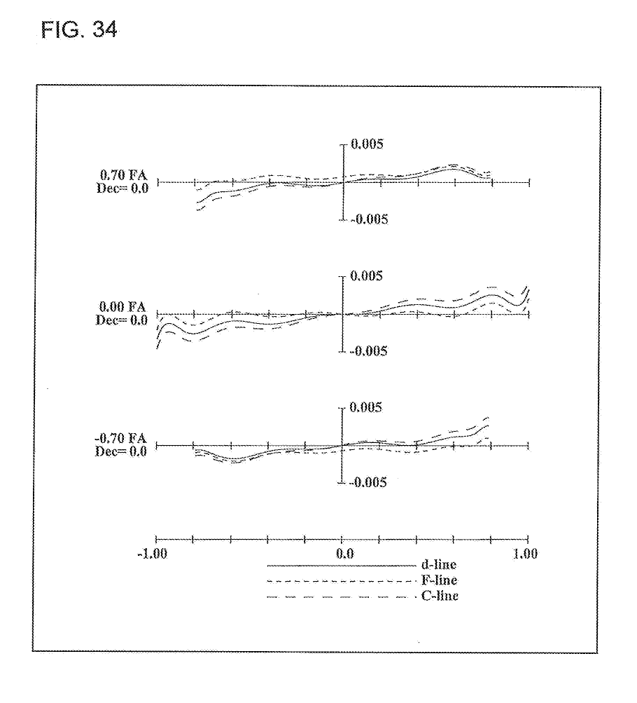

FIGS. 31 and 34 are lateral aberration diagrams of the imaging optical systems according to Numerical Examples V-1 and V-2 in a basic state where image blur compensation is not performed, respectively.

In each lateral aberration diagram, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line, and the long dash line indicate the characteristics to the d-line, the F-line, and the C-line, respectively. In each lateral aberration diagram, the meridional plane is adopted as the plane containing the optical axis of the first lens unit G1 and the optical axis of the second lens unit G2.

In the imaging optical system according to each Numerical Example, the amount of movement of the image blur compensating lens unit (first lens unit G1) in the direction perpendicular to the optical axis in the image blur compensating state at infinity is as follows.

| Numerical | Amount of movement |
|---|---|
| Example | (mm) |
| I-1 | 0.104 |
| II-1 | 0.106 |
| II-2 | 0.105 |
| II-3 | 0.121 |
| II-4 | 0.105 |
| II-5 | 0.121 |
| V-1 | 0.019 |
| V-2 | 0.020 |

When the shooting distance is infinity, the amount of image decentering in a case that the imaging optical system inclines by only 0.3° is equal to the amount of image decentering in a case that the image blur compensating lens unit (first lens unit G1) displaces in parallel by each of the above-mentioned values in the direction perpendicular to the optical axis.

### Numerical Example I-1

The imaging optical system of Numerical Example I-1 corresponds to Embodiment I-1 shown in FIG. 1. Table I-1, Table I-2, and Table I-3 show the surface data, the aspherical data, and the various data, respectively, of the imaging optical system of Numerical Example I-1.

TABLE I-1
(Surface data)

| Surface number | r | d | nd | vd |
|---|---|---|---|---|
| Object surface | ∞ | Variable | | |
| 1 | ∞ | 0.00000 | | |
| 2* | −2.48220 | 0.40080 | 1.54410 | 56.1 |
| 3* | −3.60930 | 0.14970 | | |
| 4 (Diaphragm) | ∞ | 0.09000 | | |
| 5 | 4.95500 | 2.26630 | 1.83481 | 42.7 |
| 6 | −2.84710 | 0.00500 | 1.56732 | 42.8 |
| 7 | −2.84710 | 0.30000 | 1.75520 | 27.5 |
| 8 | 38.28590 | 1.19820 | | |
| 9 | ∞ | 0.00000 | | |
| 10* | 24.55250 | 1.19100 | 1.54410 | 56.1 |
| 11* | −14.79100 | Variable | | |
| 12 | ∞ | 2.55870 | | |
| 13 | ∞ | 0.00000 | | |
| 14* | −6.95830 | 0.58000 | 1.54410 | 56.1 |
| 15* | 15.47090 | 0.17600 | | |
| 16 | ∞ | 0.21000 | 1.51680 | 64.2 |
| 17 | ∞ | 0.64000 | | |
| 18 | ∞ | (BF) | | |
| Image surface | ∞ | | | |

TABLE I-2
(Aspherical data)

Surface No. 2
K = −1.81077E+00, A4 = 2.32892E−02, A6 = −2.75364E−03, A8 = 1.21601E−04
A10 = −3.76909E−06, A12 = 2.12327E−05, A14 = −7.61421E−06, A16 = 9.26461E−07
Surface No. 3
K = −9.66993E+00, A4 = 5.85562E−03, A6 = 4.48105E−03, A8 = −1.54795E−03
A10 = 1.65372E−04, A12 = 5.52306E−05, A14 = −1.91330E−05, A16 = 1.96595E−06
Surface No. 10
K = 6.89706E+00, A4 = 4.10449E−03, A6 = −5.70270E−04, A8 = 1.27538E−04
A10 = −8.15995E−05, A12 = 1.65260E−05, A14 = −1.78975E−06, A16 = 3.35417E−08
Surface No. 11
K = −5.07768E+00, A4 = 7.79242E−03, A6 = −8.06234E−05, A8 = 1.28218E−04
A10 = −3.97728E−05, A12 = 2.79920E−06, A14 = −3.69727E−08, A16 = −3.92930E−10
Surface No. 14
K = −2.48834E+00, A4 = −7.66707E−03, A6 = −3.83296E−05, A8 = 1.08045E−04
A10 = −5.30919E−06, A12 = −4.95758E−07, A14 = 4.93888E−08, A16 = −1.13575E−09
Surface No. 15
K = 7.66302E+00, A4 = −5.72862E−03, A6 = −1.36750E−04, A8 = 4.67227E−05
A10 = −4.23040E−06, A12 = 2.32936E−07, A14 = −9.25912E−09, A16 = 1.72207E−10

TABLE I-3
(Various data)

| | ∞ | 30 cm | 15 cm |
|---|---|---|---|
| Focal length | 6.7659 | 6.6627 | 6.5598 |
| F-number | 2.50019 | 2.53733 | 2.57549 |
| Half view angle | 40.3638 | 39.9481 | 39.5361 |
| Image height | 5.1000 | 5.1000 | 5.1000 |
| Overall length of lens | 9.7724 | 9.8916 | 10.0142 |
| BF | 0.00668 | 0.00715 | 0.00751 |
| d11 | 0.0000 | 0.1188 | 0.2410 |
| Entrance pupil position | 0.3785 | 0.3785 | 0.3785 |
| Exit pupil position | −5.0631 | −5.1000 | −5.1373 |
| Front principal point position | −1.8851 | −1.9182 | −1.9512 |
| Rear principal point position | 3.0065 | 3.0766 | 3.1502 |

Single lens data

| | Initial | Focal |
|---|---|---|
| Lens | surface No. | length |
| 1 | 2 | −16.7017 |
| 2 | 5 | 2.4958 |
| 3 | 7 | −3.4981 |
| 4 | 10 | 17.1474 |
| 5 | 14 | −8.7415 |

Lens unit data

| | Initial | Focal | Overall length | Front principal | Rear principal |
|---|---|---|---|---|---|
| Unit | surface No. | length | of lens unit | point position | point position |
| 1 | 1 | 5.93853 | 5.60100 | 1.88390 | 3.40560 |
| 2 | 12 | −8.74152 | 3.52470 | 2.67418 | 2.95350 |

### Numerical Example II-1

The imaging optical system of Numerical Example II-1 corresponds to Embodiment II-1 shown in FIG. 4. Table II-1, Table II-2, and Table II-3 show the surface data, the aspherical data, and the various data, respectively, of the imaging optical system of Numerical Example II-1.

TABLE II-1
(Surface data)

| Surface number | r | d | nd | vd |
|---|---|---|---|---|
| Object surface | ∞ | Variable | | |
| 1* | −7.46200 | 0.39900 | 1.54410 | 56.1 |
| 2* | 16.37290 | 0.30000 | | |
| 3 (Diaphragm) | ∞ | 0.09000 | | |
| 4* | 5.02490 | 0.90440 | 1.85976 | 40.5 |
| 5 | −9.38460 | 0.10000 | | |
| 6 | 177.56670 | 0.80000 | 1.88100 | 40.1 |
| 7 | −4.13700 | 0.00500 | 1.56732 | 42.8 |
| 8 | −4.13700 | 0.30000 | 1.84666 | 23.8 |
| 9 | 12.84180 | 1.00000 | | |
| 10* | −5.37750 | 1.07880 | 1.54410 | 56.1 |
| 11* | −3.35970 | Variable | | |
| 12* | −7.36800 | 0.58330 | 1.54410 | 56.1 |
| 13* | 18.56200 | 0.19150 | | |
| 14 | ∞ | 0.21000 | 1.51680 | 64.2 |
| 15 | ∞ | (BF) | | |
| Image surface | ∞ | | | |

TABLE II-2
(Aspherical data)

Surface No. 1
K = 0.00000E+00, A4 = −5.40406E−04, A6 = 2.31065E−03, A8 = −8.55530E−04
A10 = 1.57234E−04, A12 = 1.82248E−05, A14 = −1.75663E−05, A16 = 2.60336E−06
Surface No. 2
K = 0.00000E+00, A4 = 1.23304E−03, A6 = 3.99433E−03, A8 = −1.01299E−03
A10 = 2.47358E−04, A12 = −4.70886E−05, A14 = −8.10191E−06, A16 = 3.40626E−06
Surface No. 4
K = 0.00000E+00, A4 = −1.45505E−03, A6 = 1.03780E−03, A8 = −2.03798E−04
A10 = 1.39543E−05, A12 = 0.00000E+00, A14 = 0.00000E+00, A16 = 0.00000E+00
Surface No. 10
K = −2.09685E+00, A4 = −6.93204E−03, A6 = 1.40348E−05, A8 = 5.04593E−04
A10 = −3.52386E−04, A12 = 1.06923E−04, A14 = −2.67160E−06, A16 = −2.59546E−06
Surface No. 11
K = −8.76207E−01, A4 = −7.41626E−04, A6 = −8.46557E−05, A8 = 2.22629E−04
A10 = −2.30213E−05, A12 = 2.74051E−08, A14 = 1.97483E−06, A16 = −2.56480E−07
Surface No. 12
K = 2.27732E+00, A4 = −5.43148E−03, A6 = 7.71250E−04, A8 = −9.09560E−05
A10 = 1.00270E−05, A12 = −5.92314E−07, A14 = 1.42114E−08, A16 = 3.63659E−11
Surface No. 13
K = 0.00000E+00, A4 = −4.53243E−03, A6 = 1.25561E−04, A8 = −1.01267E−05
A10 = 6.10301E−07, A12 = −1.44373E−08, A14 = −4.58501E−10, A16 = 2.36669E−11

TABLE II-3
(Various data)

| | ∞ | 15 cm |
|---|---|---|
| Focal length | 6.8630 | 6.6678 |
| F-number | 2.46404 | 2.53489 |
| Half view angle | 41.2826 | 40.4849 |
| Image height | 5.3170 | 5.3170 |
| Overall length of lens | 9.9700 | 10.2237 |
| BF | 0.63637 | 0.64047 |
| d11 | 3.3716 | 3.6212 |

Lens unit data

| | Initial | Focal |
|---|---|---|
| Unit | surface No. | length |
| 1 | 1 | 6.08225 |
| 2 | 12 | −9.61754 |

### Numerical Example II-2

The imaging optical system of Numerical Example II-2 corresponds to Embodiment II-2 shown in FIG. 6. Table II-4, Table II-5, and Table II-6 show the surface data, the aspherical data, and the various data, respectively, of the imaging optical system of Numerical Example II-2.

TABLE II-4
(Surface data)

| Surface number | r | d | nd | vd |
|---|---|---|---|---|
| Object surface | ∞ | Variable | | |
| 1* | −5.07330 | 0.40000 | 1.54410 | 56.1 |
| 2* | 78.11670 | 0.35480 | | |
| 3 (Diaphragm) | ∞ | 0.05000 | | |
| 4* | 4.88380 | 0.98690 | 1.80998 | 40.9 |
| 5 | −7.47020 | 0.05000 | | |
| 6 | 86.52400 | 0.75000 | 1.88100 | 40.1 |
| 7 | −4.68780 | 0.00500 | 1.56732 | 42.8 |
| 8 | −4.68780 | 0.30000 | 1.84666 | 23.8 |
| 9 | 10.71480 | 1.53740 | | |
| 10* | −8.53280 | 0.94410 | 1.54410 | 56.1 |
| 11* | −4.07870 | Variable | | |
| 12* | −10.27360 | 0.58000 | 1.54410 | 56.1 |
| 13* | 8.50700 | 0.25000 | | |
| 14 | ∞ | 0.21000 | 1.51680 | 64.2 |
| 15 | ∞ | (BF) | | |
| Image surface | ∞ | | | |

TABLE II-5
(Aspherical data)

Surface No. 1
K = 0.00000E+00, A4 = 2.31310E−03, A6 = 3.57319E−03, A8 = −1.30414E−03
A10 = 1.10511E−04, A12 = 5.14016E−05, A14 = −1.60456E−05, A16 = 1.41280E−06
Surface No. 2
K = 0.00000E+00, A4 = −8.22312E−04, A6 = 7.46075E−03, A8 = −2.75832E−03
A10 = 7.00398E−04, A12 = −9.51586E−05, A14 = −8.09650E−06, A16 = 3.40791E−06
Surface No. 4
K = 0.00000E+00, A4 = −4.93124E−03, A6 = 2.02958E−03, A8 = −4.53318E−04
A10 = 4.14801E−05, A12 = 0.00000E+00, A14 = 0.00000E+00, A16 = 0.00000E+00
Surface No. 10
K = −1.06925E+01, A4 = −3.27042E−03, A6 = −1.91914E−03, A8 = 1.19966E−03
A10 = −3.97578E−04, A12 = 5.05184E−05, A14 = 8.10236E−07, A16 = −7.06955E−07
Surface No. 11
K = −1.36778E+00, A4 = 2.81809E−04, A6 = −5.43725E−04, A8 = 2.11451E−04
A10 = −1.17438E−05, A12 = −5.33230E−06, A14 = 9.80688E−07, A16 = −6.15578E−08
Surface No. 12
K = 5.37589E+00, A4 = −1.08499E−02, A6 = 1.23193E−03, A8 = −9.66276E−05
A10 = 8.66478E−06, A12 = −5.69348E−07, A14 = 1.79836E−08, A16 = −1.19305E−10
Surface No. 13
K = 0.00000E+00, A4 = −9.82700E−03, A6 = 6.51759E−04, A8 = −3.96684E−05
A10 = 1.27893E−06, A12 = −2.77229E−09, A14 = −1.29955E−09, A16 = 3.22936E−11

TABLE II-6
(Various data)

| | ∞ | 15 cm |
|---|---|---|
| Focal length | 6.8629 | 6.6419 |
| F-number | 2.46550 | 2.53265 |
| Half view angle | 42.1280 | 41.2455 |
| Image height | 5.3500 | 5.3500 |
| Overall length of lens | 9.9700 | 10.2167 |
| BF | 0.63985 | 0.64003 |
| d11 | 2.9119 | 3.1585 |

Lens unit data

| | Initial | Focal |
|---|---|---|
| Unit | surface No. | length |
| 1 | 1 | 6.01253 |
| 2 | 12 | −8.46078 |

### Numerical Example II-3

The imaging optical system of Numerical Example II-3 corresponds to Embodiment II-3 shown in FIG. 8. Table II-7, Table II-8, and Table II-9 show the surface data, the aspherical data, and the various data, respectively, of the imaging optical system of Numerical Example II-3.

TABLE II-7
(Surface data)

| Surface number | r | d | nd | vd |
|---|---|---|---|---|
| Object surface | ∞ | Variable | | |
| 1* | −15.97950 | 0.45880 | 1.54410 | 56.1 |
| 2* | 11.85850 | 0.60430 | | |
| 3* | 5.38360 | 1.33220 | 1.77200 | 50.0 |
| 4 | −8.34870 | 0.10000 | | |
| 5 (Diaphragm) | ∞ | 0.01500 | | |
| 6 | 42.78430 | 0.83350 | 1.88100 | 40.1 |
| 7 | −6.71210 | 0.00570 | 1.56732 | 42.8 |
| 8 | −6.71210 | 0.34500 | 1.80518 | 25.5 |
| 9 | 8.23210 | 1.15000 | | |
| 10* | −5.26100 | 1.01950 | 1.54410 | 56.1 |
| 11* | −3.53850 | Variable | | |
| 12* | −7.53350 | 0.67080 | 1.54410 | 56.1 |
| 13* | 19.67630 | 0.15180 | | |
| 14 | ∞ | 0.24150 | 1.51680 | 64.2 |
| 15 | ∞ | 0.73600 | | |
| 16 | ∞ | 0.00000 | | |
| 17 | ∞ | (BF) | | |
| Image surface | ∞ | | | |

TABLE II-8
(Aspherical data)

Surface No. 1
K = 4.55077E+01, A4 = −3.51463E−03, A6 = 1.87356E−03, A8 = −3.21537E−04
A10 = 2.93969E−05, A12 = 6.78736E−06, A14 = −2.78885E−06, A16 = 3.19939E−07
Surface No. 2
K = 0.00000E+00, A4 = −3.09675E−03, A6 = 2.48779E−03, A8 = −4.12504E−04
A10 = 7.56015E−05, A12 = −1.09652E−05, A14 = −1.31679E−06, A16 = 4.18611E−07
Surface No. 3
K = 0.00000E+00, A4 = −1.25727E−03, A6 = 4.78558E−04, A8 = −6.98420E−05
A10 = 3.70823E−06, A12 = 0.00000E+00, A14 = 0.00000E+00, A16 = 0.00000E+00
Surface No. 10
K = −6.28384E−01, A4 = −6.61680E−03, A6 = 1.01297E−05, A8 = −2.63515E−05
A10 = −6.42648E−05, A12 = 2.29066E−05, A14 = −4.34210E−07, A16 = −3.18968E−07
Surface No. 11
K = −5.42002E−01, A4 = −2.13110E−03, A6 = 1.59070E−04, A8 = −1.06675E−05
A10 = −1.18457E−05, A12 = 4.44548E−06, A14 = 8.01388E−08, A16 = −3.23921E−08
Surface No. 12
K = 1.99550E−01, A4 = −5.75000E−03, A6 = 5.75624E−04, A8 = −4.55564E−05
A10 = 2.64985E−06, A12 = −1.03630E−07, A14 = 3.26366E−09, A16 = −5.60599E−11
Surface No. 13
K = −1.00000E+01, A4 = −4.44577E−03, A6 = 2.36550E−04, A8 = −1.31274E−05
A10 = 1.97883E−07, A12 = 2.91078E−09, A14 = 2.31768E−11, A16 = −2.38473E−12

TABLE II-9
(Various data)

| | ∞ | 15 cm |
|---|---|---|
| Focal length | 7.8926 | 7.6141 |
| F-number | 2.30062 | 2.39547 |
| Half view angle | 36.5608 | 35.4472 |
| Image height | 5.3720 | 5.3720 |
| Overall length of lens | 11.3304 | 11.6646 |
| BF | −0.00420 | 0.01049 |
| d11 | 3.6705 | 3.9900 |

Lens unit data

| | Initial | Focal |
|---|---|---|
| Unit | surface No. | length |
| 1 | 1 | 6.94510 |
| 2 | 12 | −9.92612 |

### Numerical Example II-4

The imaging optical system of Numerical Example II-4 corresponds to Embodiment II-4 shown in FIG. 10. Table II-10, Table II-11, and Table II-12 show the surface data, the aspherical data, and the various data, respectively, of the imaging optical system of Numerical Example II-4.

TABLE II-10
(Surface data)

| Surface number | r | d | nd | vd |
|---|---|---|---|---|
| Object surface | ∞ | Variable | | |
| 1* | −7.06290 | 0.39900 | 1.54410 | 56.1 |
| 2* | 23.43830 | 0.40450 | | |
| 3* | 5.02260 | 0.84930 | 1.88349 | 40.7 |
| 4 | −14.19600 | 0.10000 | | |
| 5 | 23.76530 | 0.80000 | 1.88300 | 40.8 |
| 6 | −4.73350 | 0.00500 | 1.56732 | 42.8 |
| 7 | −4.73350 | 0.30000 | 1.90475 | 23.7 |
| 8 | 12.18990 | 0.30000 | | |
| 9 (Diaphragm) | ∞ | 0.70000 | | |
| 10* | −6.02000 | 1.07880 | 1.54410 | 56.1 |
| 11* | −3.38120 | Variable | | |
| 12* | −5.95610 | 0.58330 | 1.54410 | 56.1 |
| 13* | 27.79490 | 0.17280 | | |
| 14 | ∞ | 0.21000 | 1.51680 | 64.2 |
| 15 | ∞ | 0.64000 | | |
| 16 | ∞ | 0.00000 | | |
| 17 | ∞ | (BF) | | |
| Image surface | ∞ | | | |

TABLE II-11
(Aspherical data)

Surface No. 1
K = 0.00000E+00, A4 = 2.68209E−03, A6 = 1.78986E−03, A8 = −7.02334E−04
A10 = 1.27279E−04, A12 = 2.09381E−05, A14 = −1.75663E−05, A16 = 2.60336E−06
Surface No. 2
K = 0.00000E+00, A4 = 4.49723E−03, A6 = 3.43759E−03, A8 = −8.88983E−04
A10 = 2.35902E−04, A12 = −4.70886E−05, A14 = −8.10191E−06, A16 = 3.40626E−06
Surface No. 3
K = 0.00000E+00, A4 = −6.41417E−04, A6 = 1.01295E−03, A8 = −2.04032E−04
A10 = 1.65511E−05, A12 = 0.00000E+00, A14 = 0.00000E+00, A16 = 0.00000E+00
Surface No. 10
K = −2.07020E+00, A4 = −7.02752E−03, A6 = −2.04875E−04, A8 = 5.81624E−04
A10 = −3.75380E−04, A12 = 1.06923E−04, A14 = −2.67160E−06, A16 = −2.59546E−06
Surface No. 11
K = −8.78660E−01, A4 = −7.40140E−04, A6 = −1.80439E−05, A8 = 1.68857E−04
A10 = −6.23929E−06, A12 = −1.57566E−06, A14 = 1.86259E−06, A16 = −2.39740E−07
Surface No. 12
K = 1.02650E+00, A4 = −3.18591E−03, A6 = 6.72284E−04, A8 = −9.24105E−05
A10 = 1.05390E−05, A12 = −5.96169E−07, A14 = 1.23880E−08, A16 = 8.68036E−11
Surface No. 13
K = 3.55604E+01, A4 = −3.32205E−03, A6 = 1.48905E−05, A8 = −4.04530E−06
A10 = 3.25289E−07, A12 = −1.57596E−08, A14 = 3.95216E−10, A16 = −3.71203E−12

TABLE II-12
(Various data)

| | ∞ | 15 cm |
|---|---|---|
| Focal length | 6.8629 | 6.6605 |
| F-number | 2.46512 | 2.56226 |
| Half view angle | 41.6562 | 40.5887 |
| Image height | 5.3720 | 5.3720 |
| Overall length of lens | 9.8876 | 10.1379 |
| BF | −0.00800 | 0.00343 |
| d11 | 3.3529 | 3.5918 |

Lens unit data

| | Initial | Focal |
|---|---|---|
| Unit | surface No. | length |
| 1 | 1 | 6.02129 |
| 2 | 12 | −8.96035 |

### Numerical Example II-5

The imaging optical system of Numerical Example II-5 corresponds to Embodiment II-5 shown in FIG. 112. Table II-13, Table II-14, and Table II-15 show the surface data, the aspherical data, and the various data, respectively, of the imaging optical system of Numerical Example II-5.

TABLE II-13
(Surface data)

| Surface number | r | d | nd | vd |
|---|---|---|---|---|
| Object surface | ∞ | Variable | | |
| 1* | 15.49130 | 0.66660 | 1.54410 | 56.1 |
| 2 | −21.77200 | 0.33110 | | |
| 3* | −5.89930 | 0.40000 | 1.54410 | 56.1 |
| 4 | 95.89790 | 0.32340 | | |
| 5 (Diaphragm) | ∞ | 0.09000 | | |
| 6* | 5.01690 | 0.61310 | 1.54410 | 56.1 |
| 7 | 19.15290 | 0.20000 | | |
| 8 | 6.37370 | 1.34160 | 1.88100 | 40.1 |
| 9 | −5.53230 | 0.00500 | 1.56732 | 42.8 |
| 10 | −5.53230 | 0.30270 | 1.75520 | 27.5 |
| 11 | 6.17300 | 0.66730 | | |
| 12* | −22.78280 | 2.24100 | 1.54410 | 56.1 |
| 13* | −5.19500 | Variable | | |
| 14* | −5.97980 | 0.58000 | 1.54410 | 56.1 |
| 15* | 15.46740 | 0.19200 | | |
| 16 | ∞ | 0.21000 | 1.51680 | 64.2 |
| 17 | ∞ | (BF) | | |
| Image surface | ∞ | | | |

TABLE II-14
(Aspherical data)

Surface No. 1
K = 0.00000E+00, A4 = −8.49136E−03, A6 = −6.26214E−04, A8 = 9.07818E−05
A10 = 8.65834E−06, A12 = −1.10003E−06, A14 = 0.00000E+00
Surface No. 3
K = 0.00000E+00, A4 = 2.90090E−02, A6 = −4.61475E−03, A8 = 1.03094E−03
A10 = −1.56204E−04, A12 = 9.56995E−06, A14 = 0.00000E+00
Surface No. 6
K = 0.00000E+00, A4 = −1.83663E−02, A6 = 3.45042E−03, A8 = −6.31002E−04
A10 = 5.23439E−05, A12 = 0.00000E+00, A14 = 0.00000E+00
Surface No. 12
K = 3.14563E+00, A4 = −1.30225E−03, A6 = −7.01101E−04, A8 = 4.22100E−04
A10 = −1.45096E−04, A12 = 2.59612E−05, A14 = −1.91149E−06
Surface No. 13
K = 0.00000E+00, A4 = 1.63809E−04, A6 = −9.33183E−05, A8 = 1.43438E−05
A10 = −4.56580E−07, A12 = 0.00000E+00, A14 = 0.00000E+00
Surface No. 14
K = −2.11716E−01, A4 = −9.69657E−03, A6 = 8.99643E−04, A8 = −7.24404E−05
A10 = 5.59702E−06, A12 = −3.05384E−07, A14 = 7.38645E−09
Surface No. 15
K = −7.38559E+00, A4 = −6.82818E−03, A6 = 5.05452E−04, A8 = −3.73353E−05
A10 = 1.78727E−06, A12 = −5.08396E−08, A14 = 6.45192E−10

TABLE II-15
(Various data)

| | ∞ | 15 cm |
|---|---|---|
| Focal length | 8.0132 | 7.6456 |
| F-number | 2.45518 | 2.53694 |
| Half view angle | 36.2948 | 35.1675 |
| Image height | 5.3700 | 5.3700 |
| Overall length of lens | 11.8213 | 12.1482 |
| BF | 0.64797 | 0.64915 |
| d13 | 3.0095 | 3.3353 |

Lens unit data

| | Initial | Focal |
|---|---|---|
| Unit | surface No. | length |
| 1 | 1 | 6.91511 |
| 2 | 14 | −7.85119 |

### Numerical Example III-1

The imaging optical system of Numerical Example III-1 corresponds to Embodiment III-1 shown in FIG. 15. Table III-1, Table III-2, and Table III-3 show the surface data, the aspherical data, and the various data, respectively, of the imaging optical system of Numerical Example III-1.

TABLE III-1
(Surface data)

| Surface number | r | d | nd | vd |
|---|---|---|---|---|
| Object surface | ∞ | Variable | | |
| 1* | −7.57220 | 0.50000 | 1.54360 | 56.0 |
| 2* | 15.46510 | 0.56330 | | |
| 3 | 16.69050 | 1.16510 | 2.00100 | 29.1 |
| 4 | −20.85140 | 0.90000 | | |
| 5 (Diaphragm) | ∞ | 0.10000 | | |
| 6 | 10.33920 | 1.53030 | 2.00100 | 29.1 |
| 7 | −5.72360 | 0.01000 | 1.56732 | 42.8 |
| 8 | −5.72360 | 0.50000 | 1.92286 | 20.9 |
| 9 | 7.38460 | 0.92910 | | |
| 10* | −1232.29070 | 1.25020 | 1.80998 | 40.9 |
| 11* | −9.37040 | Variable | | |
| 12* | −28.49540 | 0.60000 | 1.54360 | 56.0 |
| 13* | 75.69850 | 0.10000 | | |
| 14 | 21.16620 | 1.85220 | 1.90366 | 31.3 |
| 15 | 100.00000 | 2.00000 | | |
| 16 | ∞ | (BF) | | |
| Image surface | ∞ | | | |

TABLE III-2
(Aspherical data)

Surface No. 1
K = 0.00000E+00, A4 = 6.69048E−03, A6 = −9.43457E−04, A8 = 8.93010E−05
A10 = −4.59716E−06, A12 = 9.61909E−08
Surface No. 2
K = 0.00000E+00, A4 = 7.43548E−03, A6 = −8.41966E−04, A8 = 6.52987E−05
A10 = −1.36706E−06, A12 = −6.44539E−08
Surface No. 10
K = 0.00000E+00, A4 = 5.56200E−04, A6 = 3.42621E−05, A8 = 9.48358E−06
A10 = −4.11303E−07, A12 = 0.00000E+00
Surface No. 11
K = 0.00000E+00, A4 = 2.50116E−04, A6 = −2.00535E−06, A8 = 7.89527E−06
A10 = 0.00000E+00, A12 = 0.00000E+00
Surface No. 12
K = 0.00000E+00, A4 = −5.16210E−04, A6 = 2.20156E−05, A8 = −1.93288E−06
A10 = 6.71661E−08, A12 = −7.01841E−10
Surface No. 13
K = 0.00000E+00, A4 = 2.27815E−04, A6 = −1.07988E−05, A8 = −2.33695E−07
A10 = 1.21185E−08, A12 = −1.02787E−10

TABLE III-3
(Various data)

| | Retracted | ∞ | Nearest end |
|---|---|---|---|
| Focal length | — | 10.7123 | 10.7805 |
| F-number | — | 2.88481 | 3.06116 |
| Half view angle | — | 39.6781 | 37.4110 |
| Image height | — | 8.0000 | 8.0000 |
| Overall length of lens | 15.2002 | 19.0026 | 19.8279 |
| BF | — | 0.00000 | 0.00000 |
| d0 | — | ∞ | 150.0000 |
| d11 | — | 7.0024 | 7.8277 |

Single lens data

| | Initial | Focal |
|---|---|---|
| Lens | surface No. | length |
| 1 | 1 | −9.2802 |
| 2 | 3 | 9.4069 |
| 3 | 6 | 3.8646 |
| 4 | 8 | −3.4311 |
| 5 | 10 | 11.6520 |
| 6 | 12 | −38.0067 |
| 7 | 14 | 29.3839 |

### Numerical Example III-2

The imaging optical system of Numerical Example III-2 corresponds to Embodiment III-2 shown in FIG. 17. Table III-4, Table III-5, and Table III-6 show the surface data, the aspherical data, and the various data, respectively, of the imaging optical system of Numerical Example III-2.

TABLE III-4
(Surface data)

| Surface number | r | d | nd | vd |
|---|---|---|---|---|
| Object surface | ∞ | Variable | | |
| 1* | −4.65110 | 0.49000 | 1.54410 | 55.6 |
| 2* | −6.99800 | 1.25000 | | |
| 3 (Diaphragm) | ∞ | 0.75000 | | |
| 4 | 6.90600 | 1.54000 | 2.00069 | 25.5 |
| 5 | −5.91030 | 0.01000 | 1.56732 | 42.8 |
| 6 | −5.91030 | 0.30000 | 1.94595 | 18.0 |
| 7 | 13.77170 | 0.95740 | | |
| 8* | −7.53830 | 1.40000 | 1.54410 | 55.6 |
| 9* | −4.56090 | Variable | | |
| 10* | −9.06620 | 0.63000 | 1.63450 | 23.9 |
| 11* | 503.57710 | 0.23850 | | |
| 12 | 39.95560 | 1.23000 | 1.90366 | 31.3 |
| 13 | 995.70600 | 0.35940 | | |
| 14 | ∞ | 0.54000 | 1.51680 | 64.2 |
| 15 | ∞ | 1.16000 | | |
| 16 | ∞ | (BF) | | |
| Image surface | ∞ | | | |

TABLE III-5
(Aspherical data)

Surface No. 1
K = −6.02670E+00, A4 = 1.82982E−03, A6 = 2.70942E−04, A8 = −4.64512E−05
A10 = 2.58920E−06, A12 = 0.00000E+00, A14 = 0.00000E+00
Surface No. 2
K = −2.13658E+01, A4 = 7.35493E−04, A6 = 8.10019E−04, A8 = −1.18060E−04
A10 = 7.11999E−06, A12 = 0.00000E+00, A14 = 0.00000E+00
Surface No. 8
K = 0.00000E+00, A4 = −1.68558E−03, A6 = −5.30946E−04, A8 = 1.50265E−04
A10 = −2.32996E−05, A12 = 2.66205E−06, A14 = −8.07118E−08
Surface No. 9
K = −7.16324E−01, A4 = −7.85660E−04, A6 = −2.17517E−05, A8 = 1.59535E−06
A10 = 1.59288E−06, A12 = −2.97487E−08, A14 = 1.39669E−08
Surface No. 10
K = 0.00000E+00, A4 = −1.25647E−03, A6 = 5.95607E−05, A8 = −1.50192E−05
A10 = 8.93460E−07, A12 = −2.00860E−08, A14 = 1.31238E−10
Surface No. 11
K = 0.00000E+00, A4 = −5.64769E−04, A6 = −4.72222E−05, A8 = 2.82235E−07
A10 = 3.61880E−08, A12 = −3.05650E−10, A14 = −4.91323E−12

TABLE III-6
(Various data)

| | Retracted | ∞ | Nearest end |
|---|---|---|---|
| Focal length | — | 10.6452 | 10.1657 |
| F-number | — | 2.89475 | 3.08889 |
| Half view angle | — | 36.5218 | 34.7624 |
| Image height | — | 7.8920 | 7.8920 |
| Overall length of lens | 11.0053 | 16.6351 | 17.4653 |
| BF | — | 0.00000 | 0.00000 |
| d0 | — | ∞ | 100.0000 |
| d9 | — | 5.7798 | 6.6100 |

Single lens data

| | Initial | Focal |
|---|---|---|
| Lens | surface No. | length |
| 1 | 1 | −27.5134 |
| 2 | 4 | 3.3860 |
| 3 | 6 | −4.3397 |
| 4 | 8 | 18.2065 |
| 5 | 10 | −14.0293 |
| 6 | 12 | 46.0357 |

### Numerical Example III-3

The imaging optical system of Numerical Example III-3 corresponds to Embodiment III-3 shown in FIG. 19. Table III-7, Table III-8, and Table III-9 show the surface data, the aspherical data, and the various data, respectively, of the imaging optical system of Numerical Example III-3.

TABLE III-7
(Surface data)

| Surface number | r | d | nd | vd |
|---|---|---|---|---|
| Object surface | ∞ | Variable | | |
| 1* | −4.35630 | 0.60000 | 1.54360 | 56.0 |
| 2* | −5.87190 | 0.60000 | | |
| 3 (Diaphragm) | ∞ | 0.40000 | | |
| 4 | 7.09060 | 1.58780 | 2.00069 | 25.5 |
| 5 | −7.09060 | 0.01000 | 1.56732 | 42.8 |
| 6 | −7.09060 | 0.30000 | 1.94595 | 18.0 |
| 7 | 12.34950 | 1.43090 | | |
| 8* | −7.00000 | 1.93420 | 1.58254 | 59.5 |
| 9* | −4.20380 | Variable | | |
| 10* | −9.25510 | 0.80000 | 1.63451 | 23.9 |
| 11* | 56.67240 | 0.27000 | | |
| 12 | 30.50410 | 1.59490 | 1.90366 | 31.3 |
| 13 | −168.19990 | 0.20000 | | |
| 14 | ∞ | 0.54000 | 1.51680 | 64.2 |
| 15 | ∞ | 1.16000 | | |
| 16 | ∞ | (BF) | | |
| Image surface | ∞ | | | |

TABLE III-8
(Aspherical data)

Surface No. 1
K = −7.55958E+00, A4 = −1.63097E−03, A6 = 1.22281E−03, A8 = −2.94708E−04
A10 = 4.92265E−05, A12 = −4.93583E−06, A14 = 2.14105E−07
Surface No. 2
K = 1.48671E−01, A4 = 8.52008E−03, A6 = −3.93847E−04, A8 = 2.12278E−05
A10 = 6.65415E−06, A12 = −2.12931E−06, A14 = 1.76945E−07
Surface No. 8
K = 0.00000E+00, A4 = −2.85619E−03, A6 = −3.53571E−04, A8 = 4.99911E−05
A10 = −1.33631E−05, A12 = 1.60479E−06, A14 = −3.70810E−08
Surface No. 9
K = −6.52802E−01, A4 = −9.88708E−04, A6 = −1.70648E−04, A8 = 1.19662E−05
A10 = −9.32170E−08, A12 = −1.76220E−07, A14 = 1.60073E−08
Surface No. 10
K = 0.00000E+00, A4 = 1.45083E−04, A6 = 2.45427E−05, A8 = −1.33404E−05
A10 = 9.13860E−07, A12 = −2.33085E−08, A14 = 2.08942E−10
Surface No. 11
K = 0.00000E+00, A4 = 3.61601E−04, A6 = −5.86258E−05, A8 = −2.61671E−07
A10 = 7.20369E−08, A12 = −1.31464E−09, A14 = 6.36255E−12

TABLE III-9
(Various data)

| | Retracted | ∞ | Nearest end |
|---|---|---|---|
| Focal length | — | 10.7037 | 10.2610 |
| F-number | — | 2.89566 | 3.07283 |
| Half view angle | — | 36.7746 | 35.1531 |
| Image height | — | 8.0000 | 8.0000 |
| Overall length of lens | 11.5778 | 16.8050 | 17.6637 |
| BF | — | 0.00000 | 0.00000 |
| d0 | — | ∞ | 100.0000 |
| d9 | — | 5.3772 | 6.2359 |

Single lens data

| | Initial | Focal |
|---|---|---|
| Lens | surface No. | length |
| 1 | 1 | −36.0777 |
| 2 | 4 | 3.7530 |
| 3 | 6 | −4.7263 |
| 4 | 8 | 14.3989 |
| 5 | 10 | −12.4799 |
| 6 | 12 | 28.6834 |

### Numerical Example IV-1

The imaging optical system of Numerical Example IV-1 corresponds to Embodiment IV-1 shown in FIG. 22. Table IV-1, Table IV-2, and Table IV-3 show the surface data, the aspherical data, and the various data, respectively, of the imaging optical system of Numerical Example IV-1.

TABLE IV-1
(Surface data)

| Surface number | r | d | nd | vd |
|---|---|---|---|---|
| Object surface | ∞ | Variable | | |
| 1* | 7.31070 | 0.50000 | 1.54410 | 56.1 |
| 2* | 8.85000 | 0.31350 | | |
| 3 (Diaphragm) | ∞ | 0.05150 | | |
| 4* | −13.70490 | 0.89240 | 1.54410 | 56.1 |
| 5* | −4.52540 | 0.05000 | | |
| 6 | 19.76500 | 0.87970 | 1.88300 | 40.8 |
| 7 | −5.31220 | 0.00520 | 1.56732 | 42.8 |
| 8 | −5.31220 | 0.44780 | 1.81727 | 24.5 |
| 9 | 74.51000 | Variable | | |
| 10* | −14.78710 | 0.94340 | 1.54410 | 56.1 |
| 11* | −5.54180 | 1.71780 | | |
| 12* | −3.95710 | 1.32160 | 1.54410 | 56.1 |
| 13* | 10.97230 | 0.21360 | | |
| 14 | ∞ | 0.21630 | 1.51680 | 64.2 |
| 15 | ∞ | (BF) | | |
| Image surface | ∞ | | | |

TABLE IV-2
(Aspherical data)

Surface No. 1
K = 0.00000E+00, A4 = −1.24751E−02, A6 = −6.81925E−04, A8 = −1.30318E−04
A10 = −1.10022E−04, A12 = 5.63872E−05, A14 = −8.90567E−06, A16 = 5.26110E−07
Surface No. 2
K = 0.00000E+00, A4 = −4.69819E−03, A6 = 1.77589E−03, A8 = −1.32671E−04
A10 = −9.29687E−05, A12 = 6.41269E−05, A14 = −1.01394E−05, A16 = 4.57177E−07
Surface No. 4
K = 0.00000E+00, A4 = 3.20511E−03, A6 = 2.53477E−03, A8 = −3.30451E−04
Surface No. 5
K = 0.00000E+00, A4 = −2.30490E−03, A6 = 2.69178E−04, A8 = −2.01150E−04
A10 = 1.69944E−05, A12 = 0.00000E+00, A14 = 0.00000E+00, A16 = 0.00000E+00
Surface No. 10
K = 0.00000E+00, A4 = −1.75363E−03, A6 = −5.77976E−04, A8 = 2.16364E−04
A10 = −5.98279E−05, A12 = 5.21144E−06, A14 = 4.04214E−08, A16 = −2.26346E−08
Surface No. 11
K = 0.00000E+00, A4 = −1.23058E−03, A6 = −4.07095E−04, A8 = 1.03363E−04
A10 = −2.23987E−05, A12 = 1.18576E−06, A14 = −1.75617E−08, A16 = 3.23449E−09
Surface No. 12
K = 0.00000E+00, A4 = −1.26758E−02, A6 = 3.93597E−04, A8 = 7.95787E−05
A10 = −1.30555E−05, A12 = −7.85888E−07, A14 = 8.69778E−08, A16 = 3.29614E−09
Surface No. 13
K = 0.00000E+00, A4 = −1.01582E−02, A6 = 8.42832E−04, A8 = −5.13871E−05
A10 = 1.58727E−06, A12 = −2.67804E−08, A14 = 3.94455E−10, A16 = −5.89140E−12

TABLE IV-3
(Various data)

| | ∞ | 15 cm |
|---|---|---|
| Focal length | 7.7129 | 7.4055 |
| F-number | 2.46957 | 2.58265 |
| Half view angle | 43.2450 | 40.7724 |
| Image height | 6.2200 | 6.2200 |
| Overall length of lens | 10.1113 | 10.4675 |
| BF | 0.66054 | 0.66629 |
| d0 | ∞ | 150.0000 |
| d9 | 1.8980 | 2.2484 |

Single lens data

| | Initial | Focal |
|---|---|---|
| Lens | surface No. | length |
| 1 | 1 | 69.3164 |
| 2 | 4 | 12.0062 |
| 3 | 6 | 4.8210 |
| 4 | 8 | −6.0521 |
| 5 | 10 | 15.7251 |
| 6 | 12 | −5.1834 |

### Numerical Example IV-2

The imaging optical system of Numerical Example IV-2 corresponds to Embodiment IV-2 shown in FIG. 24. Table IV-4, Table IV-5, and Table IV-6 show the surface data, the aspherical data, and the various data, respectively, of the imaging optical system of Numerical Example IV-2.

TABLE IV-4
(Surface data)

| Surface number | r | d | nd | vd |
|---|---|---|---|---|
| Object surface | ∞ | Variable | | |
| 1* | −64.83460 | 0.50000 | 1.54410 | 56.1 |
| 2* | 40.44600 | 0.30000 | | |
| 3 (Diaphragm) | ∞ | 0.05000 | | |
| 4* | 33.01990 | 1.09010 | 1.54410 | 56.1 |
| 5* | −4.22300 | 0.05000 | | |
| 6 | 15.12380 | 1.03590 | 1.91082 | 35.3 |
| 7 | −4.20270 | 0.00500 | 1.56732 | 42.8 |
| 8 | −4.20270 | 0.40000 | 1.80518 | 25.5 |
| 9 | 10.48520 | Variable | | |
| 10* | −13.75690 | 1.19980 | 1.54410 | 56.1 |
| 11* | −4.82990 | 1.60600 | | |
| 12* | −4.81830 | 1.17770 | 1.54410 | 56.1 |
| 13* | 8.42500 | 0.25730 | | |
| 14 | ∞ | 0.21000 | 1.51680 | 64.2 |
| 15 | ∞ | (BF) | | |
| Image surface | ∞ | | | |

TABLE IV-5
(Aspherical data)

Surface No. 1
K = 0.00000E+00, A4 = −1.49184E−02, A6 = 2.55813E−03, A8 = 3.54517E−05
A10 = −2.17765E−04, A12 = 7.80531E−05, A14 = −1.30783E−05, A16 = 8.19662E−07
Surface No. 2
K = 0.00000E+00, A4 = −9.14652E−03, A6 = 6.04897E−03, A8 = −8.38044E−04
A10 = −4.11071E−05, A12 = 8.87666E−05, A14 = −1.48901E−05, A16 = 7.12267E−07
Surface No. 4
K = 0.00000E+00, A4 = −3.17401E−03, A6 = 2.18456E−03, A8 = −6.82518E−04
A10 = 7.25466E−05, A12 = 0.00000E+00, A14 = 0.00000E+00, A16 = 0.00000E+00
Surface No. 5
K = 0.00000E+00, A4 = −3.76439E−03, A6 = −3.19555E−04, A8 = −7.47680E−05
A10 = −2.38686E−05, A12 = 0.00000E+00, A14 = 0.00000E+00, A16 = 0.00000E+00
Surface No. 10
K = 0.00000E+00, A4 = −2.58004E−03, A6 = −5.55744E−04, A8 = 2.15177E−04
A10 = −7.83619E−05, A12 = 8.83464E−06, A14 = −1.23394E−07, A16 = −3.52640E−08
Surface No. 11
K = 0.00000E+00, A4 = −1.68875E−03, A6 = −3.31614E−04, A8 = 7.56124E−05
A10 = −2.40250E−05, A12 = 2.08154E−06, A14 = −9.72969E−08, A16 = 3.29818E−09
Surface No. 12
K = 0.00000E+00, A4 = −1.72872E−02, A6 = 7.33573E−04, A8 = 2.91823E−05
A10 = −1.40360E−05, A12 = −3.71679E−07, A14 = 1.40869E−07, A16 = −4.69621E−09
Surface No. 13
K = 0.00000E+00, A4 = −1.09527E−02, A6 = 8.35704E−04, A8 = −5.27766E−05
A10 = 1.83734E−06, A12 = −4.26252E−08, A14 = 9.51620E−10, A16 = −1.49226E−11

TABLE IV-6
(Various data)

| | ∞ | 15 cm |
|---|---|---|
| Focal length | 7.1138 | 6.9102 |
| F-number | 2.46987 | 2.57993 |
| Half view angle | 43.6928 | 41.1111 |
| Image height | 5.9000 | 5.9000 |
| Overall length of lens | 10.0624 | 10.4020 |
| BF | 0.64396 | 0.64608 |
| d0 | ∞ | 150.0000 |
| d9 | 1.5366 | 1.8741 |

Single lens data

| | Initial | Focal |
|---|---|---|
| Lens | surface No. | length |
| 1 | 1 | −45.7014 |
| 2 | 4 | 6.9531 |
| 3 | 6 | 3.7055 |
| 4 | 8 | −3.6814 |
| 5 | 10 | 13.0611 |
| 6 | 12 | −5.4625 |

### Numerical Example IV-3

The imaging optical system of Numerical Example IV-3 corresponds to Embodiment IV-3 shown in FIG. 26. Table IV-7, Table IV-8, and Table IV-9 show the surface data, the aspherical data, and the various data, respectively, of the imaging optical system of Numerical Example IV-3.

TABLE IV-7
(Surface data)

| Surface number | r | d | nd | vd |
|---|---|---|---|---|
| Object surface | ∞ | Variable | | |
| 1* | 5.15230 | 0.56810 | 1.63550 | 23.9 |
| 2* | 4.46160 | 0.65540 | | |
| 3 (Diaphragm) | ∞ | 0.01000 | | |
| 4* | 34.81940 | 0.40000 | 1.68893 | 31.1 |
| 5 | 3.62120 | 0.00500 | 1.56732 | 42.8 |
| 6 | 3.62120 | 2.15050 | 1.88300 | 40.8 |
| 7 | −5.87400 | 0.34990 | | |
| 8* | −39.79810 | 0.38330 | 1.82115 | 24.1 |
| 9 | 13.58270 | Variable | | |
| 10* | 41.71430 | 0.65650 | 1.54410 | 56.1 |
| 11* | −59.09360 | 2.19420 | | |
| 12* | 99.95620 | 0.98920 | 1.54410 | 56.1 |
| 13* | 5.54000 | 0.34830 | | |
| 14 | ∞ | 0.21000 | 1.51680 | 64.2 |
| 15 | ∞ | (BF) | | |
| Image surface | ∞ | | | |

TABLE IV-8
(Aspherical data)

Surface No. 1
K = 0.00000E+00, A4 = −5.64533E−03, A6 = −8.82560E−04, A8 = −1.93024E−05
A10 = 5.23608E−06, A12 = 0.00000E+00, A14 = 0.00000E+00
Surface No. 2
K = 0.00000E+00, A4 = −1.98940E−03, A6 = −6.31388E−04, A8 = 3.09014E−05
A10 = 1.18957E−05, A12 = 0.00000E+00, A14 = 0.00000E+00
Surface No. 4
K = 0.00000E+00, A4 = 1.94778E−03, A6 = 2.25361E−04, A8 = 2.27057E−05
A10 = 0.00000E+00, A12 = 0.00000E+00, A14 = 0.00000E+00
Surface No. 8
K = 0.00000E+00, A4 = −1.48863E−03, A6 = −6.38674E−05, A8 = −2.17782E−05
A10 = −1.16679E−06, A12 = 6.84425E−09, A14 = 0.00000E+00
Surface No. 10
K = 0.00000E+00, A4 = 6.04807E−04, A6 = −1.35909E−04, A8 = 5.15315E−07
A10 = 1.75420E−08, A12 = 0.00000E+00, A14 = 0.00000E+00
Surface No. 11
K = 0.00000E+00, A4 = 2.94057E−04, A6 = −8.56795E−05, A8 = −4.75206E−06
A10 = 7.83627E−07, A12 = −5.16731E−08, A14 = 2.60647E−09
Surface No. 12
K = 0.00000E+00, A4 = −1.37084E−02, A6 = 5.76556E−04, A8 = 6.09818E−06
A10 = −4.62040E−06, A12 = 3.59687E−07, A14 = −7.97578E−09
Surface No. 13
K = 0.00000E+00, A4 = −1.31842E−02, A6 = 9.74622E−04, A8 = −5.79410E−05
A10 = 1.71800E−06, A12 = −2.07810E−08, A14 = 0.00000E+00

TABLE IV-9
(Various data)

| | ∞ | 15 cm |
|---|---|---|
| Focal length | 7.8336 | 7.6297 |
| F-number | 2.20183 | 2.31671 |
| Half view angle | 36.9476 | 35.1684 |
| Image height | 5.5000 | 5.5000 |
| Overall length of lens | 11.0729 | 11.4999 |
| BF | 0.64549 | 0.65388 |
| d0 | ∞ | 150.0000 |
| d9 | 1.5070 | 1.9256 |

Single lens data

| | Initial | Focal |
|---|---|---|
| Lens | surface No. | length |
| 1 | 1 | −76.9696 |
| 2 | 4 | −5.8972 |
| 3 | 6 | 2.8385 |
| 4 | 8 | −12.2925 |
| 5 | 10 | 45.0453 |
| 6 | 12 | −10.8193 |

### Numerical Example V-1

The imaging optical system of Numerical Example V-1 corresponds to Embodiment V-1 shown in FIG. 29. Table V-1, Table V-2, and Table V-3 show the surface data, the aspherical data, and the various data, respectively, of the imaging optical system of Numerical Example V-1.

TABLE V-1
(Surface data)

| Surface number | r | d | nd | vd |
|---|---|---|---|---|
| Object surface | ∞ | Variable | | |
| 1* | 2.85230 | 0.30000 | 1.54410 | 56.1 |
| 2* | 3.08160 | 0.20000 | | |
| 3* | −4.39760 | 0.33480 | 1.54410 | 56.1 |
| 4* | −5.30790 | 0.10000 | | |
| 5 (Diaphragm) | ∞ | 0.00000 | | |
| 6* | 2.22950 | 0.82640 | 1.54410 | 56.1 |
| 7 | −10.28610 | 0.10000 | | |
| 8 | −8.57510 | 0.30000 | 1.63550 | 23.9 |
| 9* | 5.35670 | 0.38610 | | |
| 10* | 12.30820 | 1.02010 | 1.54410 | 56.1 |
| 11* | −3.03750 | Variable | | |
| 12* | −2.65810 | 0.50000 | 1.54410 | 56.1 |
| 13* | 4.93440 | 0.19490 | | |
| 14 | ∞ | 0.21000 | 1.51680 | 64.2 |
| 15 | ∞ | (BF) | | |
| Image surface | ∞ | | | |

TABLE V-2
(Aspherical data)

Surface No. 1
K = 0.00000E+00, A4 = −5.68645E−02, A6 = −4.69711E−04, A8 = −3.49201E−02
A10 = 8.62035E−03, A12 = 2.05289E−02, A14 = −1.33715E−02, A16 = 2.43379E−03
Surface No. 2
K = 0.00000E+00, A4 = −4.40233E−02, A6 = 3.24471E−02, A8 = −6.77753E−02
A10 = 4.65190E−03, A12 = 3.12507E−02, A14 = −1.52237E−02, A16 = 2.11491E−03
Surface No. 3
K = 0.00000E+00, A4 = 9.47046E−02, A6 = 1.67562E−03, A8 = −3.50326E−02
A10 = 9.53146E−03, A12 = 0.00000E+00, A14 = 0.00000E+00, A16 = 0.00000E+00
Surface No. 4
K = 0.00000E+00, A4 = 4.14528E−02, A6 = −1.84026E−02, A8 = 1.06282E−02
A10 = −5.31124E−03, A12 = 0.00000E+00, A14 = 0.00000E+00, A16 = 0.00000E+00
Surface No. 6
K = 0.00000E+00, A4 = −3.66711E−02, A6 = 1.59722E−02, A8 = −4.97816E−03
A10 = 3.59489E−04, A12 = 0.00000E+00, A14 = 0.00000E+00, A16 = 0.00000E+00
Surface No. 9
K = 0.00000E+00, A4 = −9.27438E−03, A6 = 7.67672E−03, A8 = −2.49598E−03
A10 = 5.40070E−04, A12 = 0.00000E+00, A14 = 0.00000E+00, A16 = 0.00000E+00
Surface No. 10
K = 0.00000E+00, A4 = −1.97243E−02, A6 = −1.19755E−02, A8 = 1.38155E−02
A10 = −1.20938E−02, A12 = 3.90687E−03, A14 = −1.26161E−04, A16 = −1.04708E−04
Surface No. 11
K = 0.00000E+00, A4 = −5.11763E−03, A6 = 5.20004E−03, A8 = −1.48343E−02
A10 = 1.24280E−02, A12 = −5.68426E−03, A14 = 1.26506E−03, A16 = −9.94291E−05
Surface No. 12
K = 0.00000E+00, A4 = −7.88035E−02, A6 = 2.42338E−02, A8 = −3.54442E−03
A10 = −1.03569E−03, A12 = 4.59625E−04, A14 = −4.77849E−05, A16 = 1.04175E−06
Surface No. 13
K = 0.00000E+00, A4 = −7.37146E−02, A6 = 2.37593E−02, A8 = −6.20327E−03
A10 = 9.53919E−04, A12 = −8.65906E−05, A14 = 4.41878E−06, A16 = −1.01447E−07

TABLE V-3
(Various data)

| | ∞ | 10 cm |
|---|---|---|
| Focal length | 4.7011 | 4.4703 |
| F-number | 2.05126 | 2.11292 |
| Half view angle | 40.9363 | 40.1591 |
| Image height | 3.4520 | 3.4520 |
| Overall length of lens | 6.2783 | 6.4188 |
| BF | 0.38994 | 0.40705 |
| d0 | ∞ | 100.0000 |
| d11 | 1.4161 | 1.5394 |
| Entrance pupil position | 0.7533 | 0.7533 |
| Exit pupil position | −2.3361 | −2.3576 |
| Front principal point position | −2.6527 | −2.6144 |
| Rear principal point position | 1.5773 | 1.7334 |

Single lens data

| | Initial | Focal |
|---|---|---|
| Lens | surface No. | length |
| 1 | 1 | 48.2206 |
| 2 | 3 | −54.1447 |
| 3 | 6 | 3.4479 |
| 4 | 8 | −5.1451 |
| 5 | 10 | 4.5850 |
| 6 | 12 | −3.1030 |

Lens unit data

| | Initial | Focal | Overall length | Front principal | Rear principal |
|---|---|---|---|---|---|
| Unit | surface No. | length | of lens unit | point position | point position |
| 1 | 1 | 3.61794 | 3.56740 | 1.74544 | 2.19128 |
| 2 | 12 | −3.10298 | 0.90490 | 0.11079 | 0.36588 |

### Numerical Example V-2

The imaging optical system of Numerical Example V-2 corresponds to Embodiment V-2 shown in FIG. 32. Table V-4, Table V-5, and Table V-6 show the surface data, the aspherical data, and the various data, respectively, of the imaging optical system of Numerical Example V-2.

TABLE V-4
(Surface data)

| Surface number | r | d | nd | vd |
|---|---|---|---|---|
| Object surface | ∞ | Variable | | |
| 1* | 2.29250 | 0.28000 | 1.54410 | 56.1 |
| 2* | 2.13470 | 0.25000 | | |
| 3* | −3.32110 | 0.38090 | 1.54410 | 56.1 |
| 4* | −3.27800 | 0.10000 | | |
| 5 (Diaphragm) | ∞ | 0.00000 | | |
| 6* | 1.82830 | 0.69020 | 1.54410 | 56.1 |
| 7 | 52.78110 | 0.10000 | | |
| 8 | −21.29350 | 0.30000 | 1.63550 | 23.9 |
| 9* | 4.02830 | 0.43010 | | |
| 10* | −17.96410 | 0.63650 | 1.54410 | 56.1 |
| 11* | −2.53540 | Variable | | |
| 12* | −4.12810 | 0.70000 | 1.54410 | 56.1 |
| 13* | 5.02680 | 0.22630 | | |
| 14 | ∞ | 0.21000 | 1.51680 | 64.2 |
| 15 | ∞ | (BF) | | |
| Image surface | ∞ | | | |

TABLE V-5
(Aspherical data)

Surface No. 1
K = 0.00000E+00, A4 = −6.99680E−02, A6 = −4.18325E−02, A8 = −1.50002E−02
A10 = 5.69750E−03, A12 = 2.05292E−02, A14 = −1.33714E−02, A16 = 2.43379E−03
Surface No. 2
K = 0.00000E+00, A4 = −4.62342E−02, A6 = −6.61069E−02, A8 = 1.77978E−02
A10 = −2.12597E−02, A12 = 3.12427E−02, A14 = −1.52301E−02, A16 = 2.10959E−03
Surface No. 3
K = 0.00000E+00, A4 = 1.29764E−01, A6 = −7.78066E−02, A8 = 5.28148E−02
A10 = −1.79377E−02, A12 = 0.00000E+00, A14 = 0.00000E+00, A16 = 0.00000E+00
Surface No. 4
K = 0.00000E+00, A4 = 3.75478E−02, A6 = −4.18188E−02, A8 = 4.75274E−02
A10 = −1.48653E−02, A12 = 0.00000E+00, A14 = 0.00000E+00, A16 = 0.00000E+00
Surface No. 6
K = 0.00000E+00, A4 = −5.96781E−02, A6 = 2.32741E−02, A8 = −7.64716E−03
A10 = 6.22159E−04, A12 = 0.00000E+00, A14 = 0.00000E+00, A16 = 0.00000E+00
Surface No. 9
K = 0.00000E+00, A4 = −3.07060E−04, A6 = 2.04424E−04, A8 = −1.52500E−03
A10 = 4.55994E−04, A12 = 0.00000E+00, A14 = 0.00000E+00, A16 = 0.00000E+00
Surface No. 10
K = 0.00000E+00, A4 = −1.28166E−03, A6 = −1.57499E−02, A8 = 2.24265E−02
A10 = −1.52444E−02, A12 = 3.93156E−03, A14 = −1.03756E−04, A16 = −8.69950E−05
Surface No. 11
K = 0.00000E+00, A4 = 1.25430E−02, A6 = 1.21093E−03, A8 = −2.86807E−03
A10 = 7.83576E−03, A12 = −4.82001E−03, A14 = 1.26429E−03, A16 = −1.00144E−04
Surface No. 12
K = 0.00000E+00, A4 = −3.16569E−02, A6 = 6.02122E−03, A8 = 2.09274E−03
A10 = −1.20917E−03, A12 = 2.44975E−04, A14 = −2.33818E−05, A16 = 8.82313E−07
Surface No. 13
K = 0.00000E+00, A4 = −4.57764E−02, A6 = 1.13751E−02, A8 = −2.90412E−03
A10 = 5.21728E−04, A12 = −6.22140E−05, A14 = 4.20200E−06, A16 = −1.17837E−07

TABLE V-6
(Various data)

| | ∞ | 10 cm |
|---|---|---|
| Focal length | 4.6996 | 4.5069 |
| F-number | 2.25031 | 2.32276 |
| Half view angle | 39.7835 | 39.0194 |
| Image height | 3.3720 | 3.3720 |
| Overall length of lens | 6.2501 | 6.3997 |
| BF | 0.38239 | 0.39262 |
| d0 | ∞ | 100.0000 |
| d11 | 1.5637 | 1.7031 |
| Entrance pupil position | 0.8198 | 0.8198 |
| Exit pupil position | −2.5897 | −2.6255 |
| Front principal point position | −1.9118 | −1.9251 |
| Rear principal point position | 1.5505 | 1.6757 |

Single lens data

| | Initial | Focal |
|---|---|---|
| Lens | surface No. | length |
| 1 | 1 | −152.0967 |
| 2 | 3 | 112.8383 |
| 3 | 6 | 3.4643 |
| 4 | 8 | −5.3060 |
| 5 | 10 | 5.3478 |
| 6 | 12 | −4.0566 |

Lens unit data

| | Initial | Focal | Overall length | Front principal | Rear principal |
|---|---|---|---|---|---|
| Unit | surface No. | length | of lens unit | point position | point position |
| 1 | 1 | 3.77801 | 3.16770 | 1.54341 | 1.94793 |
| 2 | 12 | −4.05661 | 1.13630 | 0.19905 | 0.52916 |

The following Tables VI-1 to VI-3 show the corresponding values to the individual conditions in the imaging optical systems according to the respective Numerical Examples.

TABLE VI-1
(Values corresponding to conditions)

| | | | Numerical Examples | | | | | |
|---|---|---|---|---|---|---|---|---|
| Conditions | | | I-1 | II-1 | II-2 | II-3 | II-4 | II-5 |
| (1) | L_{G12}/L | | 0.26 | 0.34 | 0.29 | 0.32 | 0.34 | 0.25 |
| (2) | BF/Ir | | 0.17 | 0.16 | 0.17 | 0.18 | 0.16 | 0.16 |
| (3) | Y′/(L − L_{G12}) | | 0.80 | 0.91 | 0.88 | 0.76 | 0.93 | 0.67 |
| (4) | LA/L | | 0.94 | 0.93 | 0.92 | 0.78 | 0.68 | 0.85 |
| (5) | (R_{G1r2} − R_{G2r1})/ | | 0.36 | −0.37 | −0.43 | −0.36 | −0.28 | −0.07 |
| | (R_{G1r2} + R_{G2r1}) | | | | | | | |
| (6) | \|f_{L1}/f\| | | 2.47 | 1.36 | 1.27 | 1.58 | 1.45 | 2.09 |
| (7) | f_{G1}/f_{G2} | | −0.68 | −0.63 | −0.71 | −0.70 | −0.67 | −0.88 |
| (8) | f_{L4}/f | | 2.53 | −0.53 | −0.56 | −0.58 | −0.54 | 0.44 |
| (9) | Lₘᵢₙ/L | | 0.74 | 0.66 | 0.71 | 0.68 | 0.66 | 0.75 |
| (10) | f_{G1Li}/f | | 2.53 | 2.02 | 1.95 | 2.08 | 1.81 | 1.48 |
| (11) | Ir/R_{G1r2} | | −0.39 | −1.79 | −1.52 | −1.65 | −1.81 | −1.13 |
| (12) | nd + 0.0025 × vd − | (L1) | −0.028 | −0.028 | −0.028 | −0.028 | −0.028 | −0.028 |
| | 1.7125 | (L2) | 0.229 | 0.249 | 0.200 | 0.185 | 0.273 | −0.028 |
| | | (L3) | 0.111 | 0.269 | 0.269 | 0.269 | 0.273 | −0.028 |
| | | (L4) | −0.028 | 0.194 | 0.194 | 0.156 | 0.252 | 0.269 |
| | | (L5) | −0.028 | −0.028 | −0.028 | −0.028 | −0.028 | 0.111 |
| | | (L6) | — | −0.028 | −0.028 | −0.028 | −0.028 | −0.028 |
| | | (L7) | — | — | — | — | — | −0.028 |

TABLE VI-1I
(Values corresponding to conditions)

| | | | Numerical Examples | | |
|---|---|---|---|---|---|
| Conditions | | | III-1 | III-2 | III-3 |
| (1) | L_{G12}/L | | 0.37 | 0.35 | 0.30 |
| (2) | BF/Ir | | 0.23 | 0.24 | 0.21 |
| (3) | Y′/(L − L_{G12}) | | 0.67 | 0.74 | 0.68 |
| (4) | LA/L | | 0.84 | 0.90 | 0.93 |
| (5) | (R_{G1r2} − R_{G2r1})/ | | −0.51 | −0.33 | −0.38 |
| | (R_{G1r2} + _{RG2r1}) | | | | |
| (6) | \|f_{L1}/f\| | | 0.87 | 2.58 | 3.37 |
| (7) | f_{G1}/f_{G2} | | 0.09 | −0.44 | −0.39 |
| (8) | f_{L4}/f | | −0.32 | 1.71 | 1.35 |
| (9) | Lₘᵢₙ/L | | 0.63 | 0.65 | 0.70 |
| (10) | f_{G1Li}/f | | 1.09 | 1.71 | 1.35 |
| (11) | Ir/R_{G1r2} | | −0.95 | −1.73 | −1.90 |
| (12) | nd + 0.0025 × | (L1) | −0.029 | −0.029 | −0.029 |
| | vd − 1.7125 | (L2) | 0.361 | 0.352 | 0.352 |
| | | (L3) | 0.361 | 0.278 | 0.278 |
| | | (L4) | 0.263 | −0.029 | 0.019 |
| | | (L5) | 0.200 | −0.018 | −0.018 |
| | | (L6) | −0.029 | 0.269 | 0.269 |
| | | (L7) | 0.269 | — | — |

TABLE VI-1II
(Values corresponding to conditions)

| | | | Numerical Examples | | | | |
|---|---|---|---|---|---|---|---|
| Conditions | | | IV-1 | IV-2 | IV-3 | V-1 | V-2 |
| (1) | L_{G12}/L | | 0.19 | 0.15 | 0.14 | 0.23 | 0.25 |
| (2) | BF/Ir | | 0.14 | 0.15 | 0.19 | 0.18 | 0.19 |
| (3) | Y′/(L − L_{G12}) | | 0.88 | 0.79 | 0.62 | 0.84 | 0.83 |
| (4) | LA/L | | 0.92 | 0.92 | 0.89 | 0.85 | 0.84 |
| (5) | (R_{G1r2} − R_{G2r1})/ | | 1.50 | −7.42 | −0.51 | 0.07 | −0.24 |
| | (R_{G1r2} + R_{G2r1}) | | | | | | |
| (6) | \|f_{L1}/f\| | | 9.00 | 6.44 | 9.83 | 10.26 | 32.36 |
| (7) | f_{G1}/f_{G2} | | −0.79 | −0.60 | −0.50 | −1.17 | −0.93 |
| (8) | f_{L4}/f | | −0.79 | −0.52 | −1.57 | −1.09 | −1.13 |
| (9) | Lₘᵢₙ/L | | 0.81 | 0.85 | 0.86 | 0.77 | 0.75 |
| (10) | f_{G1Li}/f | | −0.79 | −0.52 | −1.57 | 0.98 | 1.14 |
| (11) | Ir/R_{G1r2} | | 0.10 | 0.65 | 0.43 | −1.34 | −1.54 |
| (12) | nd + | (L1) | −0.028 | −0.028 | −0.017 | −0.028 | −0.028 |
| | 0.0025 × | (L2) | −0.028 | −0.028 | 0.054 | −0.028 | −0.028 |
| | vd − 1.7125 | (L3) | 0.273 | 0.287 | 0.273 | −0.028 | −0.028 |
| | | (L4) | 0.166 | 0.156 | 0.169 | −0.017 | −0.017 |
| | | (L5) | −0.028 | −0.028 | −0.028 | −0.028 | −0.028 |
| | | (L6) | −0.028 | −0.028 | −0.028 | −0.028 | −0.028 |
| | | (L7) | — | — | — | — | — |

The imaging optical system according to the present disclosure is applicable to a camera of a smartphone, a camera of a mobile telephone, a camera of a tablet terminal, a Web camera, a monitor camera of a monitor system, an in-vehicle camera, and the like. In particular, the imaging optical system according to the present disclosure is suitable as an imaging optical system for a mobile terminal, such as a camera of a smartphone and a camera of a tablet terminal, which is required to have a wide angle of view and a compact size.

As presented above, the embodiments have been described as examples of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof.

What is claimed is:

1. An imaging optical system, in order from an object side to an image side, comprising:
a first lens unit having positive optical power; and
a second lens unit, wherein
in focusing from an infinity in-focus condition to a close-object in-focus condition, the first lens unit moves along an optical axis, and the second lens unit is fixed with respect to an image surface,
the first lens unit, in order from an object side to an image side, is composed of:
a first lens element having negative optical power; and
at least one subsequent lens element, and
an aperture diaphragm is disposed between the first lens element and the subsequent lens element.

2. The imaging optical system as claimed in claim 1, wherein the following condition (1) is satisfied:
0.07<L_{G12}/L<0.40 (1)
where
L_{G12} is an axial distance between a most-image-side lens surface of the first lens unit and a most-object-side lens surface of the second lens unit, in the infinity in-focus condition, and
L is an overall lens length showing an axial distance between the most-object-side lens surface of the first lens unit and the image surface, in the infinity in-focus condition.

3. The imaging optical system as claimed in claim 1, wherein the following condition (2) is satisfied:
0.07<BF/Ir<0.40 (2)
where
BF is an axial air conversion distance between a most-image-side lens surface of the second lens unit and the image surface, and
Ir is an image height of an imaging element represented by the following formula:
Ir=f×tan ω
where
f is a focal length of the entire system in the infinity in-focus condition, and
ω is a half view angle in the infinity in-focus condition.

4. The imaging optical system as claimed in claim 1, wherein the following condition (3) is satisfied:
0.5<Y′(L−L_{G12})<1.0 (3)
where
Y′ is a maximum image height,
L is the overall lens length showing the axial distance between the most-object-side lens surface of the first lens unit and the image surface, in the infinity in-focus condition, and
L_{G12} is the axial distance between the most-image-side lens surface of the first lens unit and the most-object-side lens surface of the second lens unit, in the infinity in-focus condition.

5. The imaging optical system as claimed in claim 1, wherein the following condition (4) is satisfied:
0.5<LA/L<1.0 (4)
where
LA is an axial distance from the aperture diaphragm to the image surface, and
L is the overall lens length showing the axial distance between the most-object-side lens surface of the first lens unit and the image surface, in the infinity in-focus condition.

6. The imaging optical system as claimed in claim 1, wherein a sign of optical power of the second lens element located closest to the object side among the subsequent lens elements is opposite to a sign of optical power of the first lens element.

7. The imaging optical system as claimed in claim 1, wherein
the most-image-side lens surface of the first lens unit has a convex surface facing the image side,
the most-object-side lens surface of the second lens unit has a concave surface facing the object side, and
the following condition (5) is satisfied:
−1.0<(R_{G1r2}−R_{G2r1})/(R_{G1r2}+R_{G2r1})<0.0 (5)
where
R_{G1r2} is a radius of curvature of the most-image-side lens surface of the first lens unit, and
R_{G2r1} is a radius of curvature of the most-object-side lens surface of the second lens unit.

8. The imaging optical system as claimed in claim 1, wherein
the following condition (6) is satisfied:
0.5<|f_{L1}/f|<5.0 (6)
where
f_{L1} is a focal length of the first lens element in the infinity in-focus condition, and
f is the focal length of the entire system in the infinity in-focus condition.

9. The imaging optical system as claimed in claim 1, wherein
the following condition (7) is satisfied:
−1.0<f_{G1}/f_{G2}<−0.3 (7)
where
f_{G1} is a composite focal length of the first lens unit in the infinity in-focus condition, and
f_{G2} is a composite focal length of the second lens unit in the infinity in-focus condition.
